(19) United States
(12) Patent Application Publication
(10) Pub. No.: US 2022/0149359 A1
(43) Pub. Date: May 12, 2022

(54) METHOD OF IRON ELECTRODE MANUFACTURE AND ARTICLES AND SYSTEMS THEREFROM

(71) Applicant: FORM ENERGY, INC., Somerville, MA (US)

(72) Inventors: Michael Andrew GIBSON, Philadelphia, PA (US); Joseph Anthony PANTANO, Canton, MA (US); Rupak CHAKRABORTY, Brookline, MA (US); Nicholas Reed PERKINS, Cambridge, MA (US); William Henry WOODFORD, Cambridge, MA (US); Valerie Christine SACHA, Cambridge, MA (US); Robert Wesley MORGAN, Arlington, MA (US); Eric WEBER, Pittsburgh, PA (US); Vincent CHEVRIER, Charlotte, NC (US); Andrew Haynes LIOTTA, Cambridge, MA (US); Karen THOMAS-ALYEA, Arlington, MA (US); Leah NATION, Cambridge, MA (US); Michael CHON, Cambridge, MA (US); Rebecca Marie EISENACH, Cambridge, MA (US)

(21) Appl. No.: 17/523,389

(22) Filed: Nov. 10, 2021

Related U.S. Application Data
(60) Provisional application No. 63/193,424, filed on May 26, 2021.
(60) Provisional application No. 63/112,539, filed on Nov. 11, 2020.

(51) Int. Cl. H01M 4/38; H01M 4/04

(52) U.S. Cl. CPC H01M 4/38; H01M 2004/021; H01M 4/043

(57) ABSTRACT

Iron electrode materials, iron electrodes, and methods for fabricating said iron electrode materials and iron electrodes via elevated temperature thermomechanical processing of porous particulate iron materials are described. For example, as part of iron electrode manufacture, a particulate iron material into an apparatus may be provided. In addition, pressure and/or heat may be applied to the particulate iron material in the apparatus for a time period to form an electrode having therein conductive connections between particles of the particulate iron material.

### RELATED APPLICATIONS

This application claims the benefit of priority to U.S. Provisional Patent Application No. 63/112,539 entitled “METHOD OF IRON ELECTRODE MANUFACTURE AND ARTICLES AND SYSTEMS THEREFROM” filed Nov. 11, 2020 and U.S. Provisional Patent Application No. 63/193,424 entitled “METHOD OF IRON ELECTRODE MANUFACTURE AND ARTICLES AND SYSTEMS THEREFROM” filed May 26, 2021, the entire contents of both of which are hereby incorporated by reference for all purposes.

### BACKGROUND

Energy storage technologies are playing an increasingly important role in electric power grids; at a most basic level, these energy storage assets provide smoothing to better match generation and demand on a grid. The services performed by energy storage devices are beneficial to electric power grids across multiple time scales, from milliseconds to years. Today, energy storage technologies exist that can support timescales from milliseconds to hours, but there is a need for long and ultra-long duration (collectively, >8 h) energy storage systems.

Direct reduced iron (DRI) is an inexpensive form of iron created by reducing iron ore into a primarily metallic oxidation state. It is available primarily in pellet or lump form, with characteristic sizes of 6-16 mm, although this varies depending on the pellets and lumps input into the reduction process.

Iron negative electrodes for energy storage applications (i.e., anodes for batteries) require high levels of microporosity (generally greater than about 40% by volume), high specific surface areas (generally greater than about 0.05 meters squared per gram), and reasonably high purities (generally greater than 80% by weight iron). Direct reduced iron satisfies all of these material property requirements at an attractive price point.

Other processes for producing highly porous iron materials (e.g., sponge irons) exist, often at fairly attractive price points for the creation of battery electrodes. These sponge irons may be produced in a particulate form. The contents of this disclosure may be generally useful for the consolidation of any iron-containing particulate electrode material which would benefit from the creation of electrical connections between particles for battery applications. In what follows, the term porous particulate irons is used to describe any such material with high levels of microporosity that may be usefully placed into electrical connection in order to form a battery material.

Battery electrodes must be both ionically and electronically conductive in order to function. While the particulate form of porous particulate irons has advantages for bulk handling and manufacturing purposes, the size and shape of the particulate form factor can pose problems if one seeks to create an electrically conductive mass of the material while substantially maintaining the porosity and microstructure internal to the porous particulate irons. That is, electronic transport through electrodes based on porous particulate irons can be challenging to the point where the performance of the electrode is limited by the electronic transport through the electrode due to e.g., point contact resistance. In many instances, the transport of electrons through these electrodes can be enhanced through the proper combination of conductive additives, compression to lower contact resistance, or other techniques. However, these techniques for enhancing the electrical conduction within and out of the electrode are often sufficiently expensive that attractive applications of iron electrodes are no longer technoecononimcally attractive. Thus, there exists a need for cost-effective techniques to provide electrical connections between porous particulate iron particles for iron battery electrodes.

A successful technique for connecting the particles within the electrode will not only result in an electrode that is electrically conductive and low cost, but will also result in an electrode with low packaging costs, low current collector costs, and provides a sufficiently robust electrode that the battery exhibits sufficient lifetime for a variety of applications. The methods, systems, and articles disclosed herein have a unique potential to address all of these needs simultaneously.

The above background provides an introduction to various aspects of the art, which may be associated with embodiments of the present disclosure. Thus, the foregoing discussion provides a framework for better understanding of various disclosed aspects herein, and is not to be viewed as an admission of prior art.

### SUMMARY

Without being limited to any specific theory or model of the reactivity of an iron electrode, possible schemes for the oxidation of iron electrodes in alkaline electrolyte can proceed according to the following two reaction steps, namely Reaction 1 and Reaction 2 below. Additional or different reaction products are possible (one of which is described in Reaction 3 below), but the characteristic of volume change through the reaction may be general to any oxidation product relative to metallic iron.

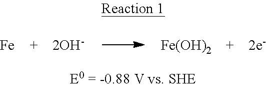

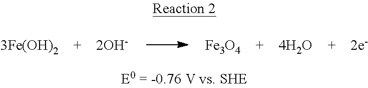

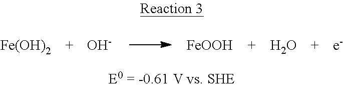

Various embodiments include iron electrode materials, iron electrodes, and methods for fabricating said iron electrode materials and iron electrodes via elevated temperature thermomechanical processing of porous particulate iron materials. In general, these techniques involve feeding, providing, or otherwise receiving a porous particulate iron material into an apparatus. Pressure and/or heat may be applied to the porous particulate iron material in the apparatus for a time period to form an electrode having therein conductive connections between particles of the particulate iron material. In some embodiments, the apparatus may simultaneously apply pressure and elevated temperature to the material to create strong, conductive connections between the particles via metallurgical bonding. The result of this thermomechanical processing may be a material composed of porous particulate iron with metallurgical bonds at the contact points between the particles. The material produced by the methods disclosed may be used as a component in a battery electrode. The electrodes produced by this method may be low cost, mechanically robust, highly scalable to large production volumes, and high performance. The materials and electrodes produced by the methods disclosed herein may be especially well-suited for applications of iron batteries for grid-scale energy storage, thereby enabling the large-scale adoption of renewable energy from intermittent energy generation sources such as wind and solar. The electrodes produced by these methods may be especially attractive in commercial applications for long duration energy storage because of the low part count needed in the electrode assembly. Under proper processing conditions, the electrodes produced by these methods may not need external current collection or packaging, but rather, may be able to be utilized in the electrochemical system as a ready-to-use assembly, with attendant savings on part and assembly costs as compared to traditional electrode designs. In some embodiments, the methods disclosed are scalable to very high production volumes with modest modifications to existing manufacturing equipment already installed today, with potential production volumes measuring in the millions of tons per year at a single plant. This level of productivity is not achievable by other battery electrode manufacturing methods. The combination of cost, performance, and scalability for the fabrication methods disclosed provides entitlement to the use of these battery electrodes to store energy at scale of tens to hundreds of gigawatt-hours with existing manufacturing equipment, representing a rapid path to truly grid-scale energy storage.

Various embodiments may include an iron electrode, comprising metallurgically-bonded sponge iron particles, wherein the microporosity with the sponge iron particles is >50 vol % and the particle size of the sponge iron particles is >100 microns.

### BRIEF DESCRIPTION OF THE DRAWINGS

The accompanying drawings, which are incorporated herein and constitute part of this specification, illustrate exemplary embodiments of the claims, and together with the general description given above and the detailed description given below, serve to explain the features of the claims.

FIGS. 1A-1C illustrate level of deformation comparisons.

FIG. 2 illustrates a hot roll compaction embodiment in which mechanically and electrically connected material is output.

FIGS. 3A and 3B illustrate an example of a comparison of unimodal packing to bimodal packing.

FIG. 4 illustrates electrode thickness, DRI pellet size, and layer size relationships.

FIG. 5 includes an Ellingham Diagram for various different elements.

FIG. 6 is an iron-carbon phase diagram.

FIGS. 7, 8A, and 8B illustrate examples of tooling and pressing operations to form channeled electrodes according to various embodiments.

FIG. 9 illustrates an example of a roller with teeth that may be suitable for use in forming a channeled electrode according to various embodiments.

FIGS. 10A and 10B illustrate views of an example channeled electrode according to various embodiments.

FIGS. 11A and 11B illustrate examples of textured rollers and operations to form a channeled electrode according to various embodiments using such textured rollers.

FIGS. 12A-12C illustrate profile views of one example of a cutting or separating feature being used to separate sheets of formed electrodes.

FIG. 13 illustrates an example electrode connection according to various embodiments.

FIG. 14 is an example of a structural facing application method according to various embodiments.

FIGS. 15-23 illustrate various example systems in which one or more aspects of the various embodiments may be used as part of bulk energy storage systems.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims. The following description of the embodiments of the invention is not intended to limit the invention to these embodiments but rather to enable a person skilled in the art to make and use this invention. Unless otherwise noted, the accompanying drawings are not drawn to scale.

As used herein, unless stated otherwise, room temperature is 25° C. And, standard temperature and pressure is 25° C. and 1 atmosphere. Unless expressly stated otherwise all tests, test results, physical properties, and values that are temperature dependent, pressure dependent, or both, are provided at standard ambient temperature and pressure.

Generally, the term “about” and the symbol “˜” as used herein unless specified otherwise is meant to encompass a variance or range of ±10%, the experimental or instrument error associated with obtaining the stated value, and preferably the larger of these.

As used herein unless specified otherwise, the recitation of ranges of values herein is merely intended to serve as a shorthand method of referring individually to each separate value falling within the range. Unless otherwise indicated herein, each individual value within a range is incorporated into the specification as if it were individually recited herein.

As used herein, unless specified otherwise the terms %, weight % and mass % are used interchangeably and refer to the weight of a first component as a percentage of the weight of the total, e.g., formulation, mixture, particle, pellet, agglomerate, material, structure or product. As used herein, unless specified otherwise “volume %” and “% volume” and similar such terms refer to the volume of a first component as a percentage of the volume of the total, e.g., formulation, mixture, particle, pellet, agglomerate, material, structure or product.

The term, “Microporosity,” as used herein refers to a material that includes pores (i.e., porosity) with a characteristics length scale of tens of microns or less.

The expression “Vol. % microporosity within the particles” as used herein refers to a volume fraction of 3-dimensionally percolating void space within a particle (i.e. within the geometric envelope of the particle) that is microporosity. After thermomechanical processing, this is used to mean the volume fraction of 3-dimensionally percolating void space within the region occupied by the material of the prior-particle after deformation. Put more simply—the particle is deformed, but in most cases where the deformation is not especially intense, one can reasonably identify a single prior particle. The Vol. % microporosity within the particles after thermomechanical processing is percent void space within the identifiable region of the prior particle.

The following examples are provided to illustrate various embodiments of the present systems and methods of the present inventions. These examples are for illustrative purposes, may be prophetic, and should not be viewed as limiting, and do not otherwise limit the scope of the present inventions.

It is noted that there is no requirement to provide or address the theory underlying the novel and groundbreaking processes, materials, performance or other beneficial features and properties that are the subject of, or associated with, embodiments of the present inventions. Nevertheless, various theories are provided in this specification to further advance the art in this area. The theories put forth in this specification, and unless expressly stated otherwise, in no way limit, restrict or narrow the scope of protection to be afforded the claimed inventions. These theories may not be required or practiced to utilize the present inventions. It is further understood that the present inventions may lead to new, and heretofore unknown theories to explain the function-features of embodiments of the methods, articles, materials, devices and system of the present inventions; and such later developed theories shall not limit the scope of protection afforded the present inventions.

The various embodiments of systems, equipment, techniques, methods, activities and operations set forth in this specification may be used for various other activities and in other fields in addition to those set forth herein. Additionally, these embodiments, for example, may be used with: other equipment or activities that may be developed in the future; and, with existing equipment or activities which may be modified, in-part, based on the teachings of this specification. Further, the various embodiments and examples set forth in this specification may be used with each other, in whole or in part, and in different and various combinations. Thus, the configurations provided in the various embodiments of this specification may be used with each other. For example, the components of an embodiment having A, A′ and B and the components of an embodiment having A″, C and D can be used with each other in various combination, e.g., A, C, D, and A. A″ C and D, etc., in accordance with the teaching of this specification. Thus, the scope of protection afforded to the present inventions should not be limited to a particular embodiment, configuration or arrangement that is set forth in a particular embodiment, example, or in an embodiment in a particular figure.

As used herein, unless specified otherwise, the terms specific gravity, which is also called apparent density, should be given their broadest possible meanings, and generally mean weight per unit until volume of a structure, e.g., volumetric shape of material. This property would include internal porosity of a particle as part of its volume. It can be measured with a low viscosity fluid that wets the particle surface, among other techniques.

As used herein, unless specified otherwise, the terms actual density, which may also be called true density, should be given their broadest possible meanings, and general mean weight per unit volume of a material, when there are no voids present in that material. This measurement and property essentially eliminates any internal porosity from the material, e.g., it does not include any voids in the material.

Thus, a collection of porous foam balls (e.g., Nerf® balls) can be used to illustrate the relationship between the three density properties. The weight of the balls filling a container would be the bulk density for the balls:

$$Bulk Density = \frac{weight of balls}{volume of container filled}$$

The weight of a single ball per the ball's spherical volume would be its apparent density:

$$Apparent Density = \frac{weight of one ball}{volume of that ball}$$

The weight of the material making up the skeleton of the ball, i.e., the ball with all void volume removed, per the remaining volume of that material would be the skeletal density:

$$Skeletal Density = \frac{weight of material}{volume of void free material}$$

As used herein, unless specified otherwise, the term agglomerate and aggregate should be given their broadest possible meanings, and in general mean assemblages of particles in a powder.

Embodiments of the present invention include apparatus, systems, and methods for long-duration, and ultra-long-duration, low-cost, energy storage. Herein, “long duration” and “ultra-long duration” and similar such terms, unless expressly stated otherwise, should be given their broadest possible meaning and include periods of energy storage of 8 hours or longer, such as periods of energy storage of 8 hours, periods of energy storage ranging from 8 hours to 20 hours, periods of energy storage of 20 hours, periods of energy storage ranging from 20 hours to 24 hours, periods of energy storage of 24 hours, periods of energy storage ranging from 24 hours to a week, periods of energy storage ranging from a week to a year (e.g., such as from several days to several weeks to several months), etc. and would include LODES systems. Further, the terms “long duration” and “ultra-long duration”, “energy storage cells” including “electrochemical cells”, and similar such terms, unless expressly stated otherwise, should be given their broadest possible interpretation; and include electrochemical cells that may be configured to store energy over time spans of days, weeks, or seasons.

In general, in an embodiment, the long duration energy storage cell can be a long duration electrochemical cell. In general, this long duration electrochemical cell can store electricity generated from an electrical generation system, when: (i) the power source or fuel for that generation is available, abundant, inexpensive, and combinations and variations of these; (ii) when the power requirements or electrical needs of the electrical grid, customer or other user, are less than the amount of electricity generated by the electrical generation system, the price paid for providing such power to the grid, customer or other user, is below an economically efficient point for the generation of such power (e.g., cost of generation exceeds market price for the electricity), and combinations and variations of these; and (iii) combinations and variations of (i) and (ii) as well as other reasons. This electricity stored in the long duration electrochemical cell can then be distributed to the grid, customer or other user, at times when it is economical or otherwise needed. For example, the electrochemical cells may be configured to store energy generated by solar cells during the summer months, when sunshine is plentiful and solar power generation exceeds power grid requirements, and discharge the stored energy during the winter months, when sunshine may be insufficient to satisfy power grid requirements.

Various embodiments are discussed in relation to the use of direct reduced iron (DRI) as a material a battery (or cell), as a component of a battery (or cell) and combinations and variations of these. In various embodiments, the DRI may be produced from, or may be, material which is obtained from the reduction of natural or processed iron ores, such reduction being conducted without reaching the melting temperature of iron. In various embodiments the iron ore may be taconite or magnetite or hematite or goethite, etc. In various embodiments, the DRI may be in the form of pellets, which may be spherical or substantially spherical. In various embodiments the DRI may be porous, containing open and/or closed internal porosity. In various embodiments the DRI may comprise materials that have been further processed by hot or cold briquetting. In various embodiments, the DRI may be produced by reducing iron ore pellets to form a more metallic (more reduced, less highly oxidized) material, such as iron metal(Fe⁰), wustite (FeO), or a composite pellet comprising iron metal and residual oxide phases. In various non-limiting embodiments, the DRI may be reduced iron ore taconite, direct reduced (“DR”) taconite, reduced “Blast Furnace (BF) Grade” pellets, reduced “Electric Arc Furnace (EAF)-Grade” pellets, “Cold Direct Reduced Iron (CDRI)” pellets, DRI pellets, Hot Briquetted Iron (HBI), or any combination thereof. In the iron and steel making industry, DRI is sometimes referred to as “sponge iron;” this usage is particularly common in India. Embodiments of iron materials, including for example embodiments of DRI materials, for use in various embodiments described herein, including as electrode materials, may have, one, more than one, or all of the material properties as described in Table 1 below. As used in the Specification, including Table 1, the following terms, have the following meaning, unless expressly stated otherwise: “Specific surface area” means, the total surface area of a material per unit of mass, which includes the surface area of the pores in a porous structure; “Carbon content” or “Carbon (wt %)” means the mass of total carbon as percent of total mass of DRI; “Cementite content” or “Cementite (wt %)” means the mass of Fe₃C as percent of total mass of DRI; “Total Fe (wt %)” means the mass of total iron as percent of total mass of DRI; “Metallic Fe (wt %)” means the mass of iron in the Fe⁰ state as percent of total mass of DRI; and “Metallization” means the mass of iron in the Fe⁰ state as percent of total iron mass. Weight and volume percentages and apparent densities as used herein are understood to exclude any electrolyte that has infiltrated porosity or fugitive additives within porosity unless otherwise stated.

TABLE 1

| Material Property | Embodiment Range |
|---|---|
| Specific surface area* | 0.01-25 m²/g |
| Actual density** | 4.6-7.1 g/cc |
| Apparent density*** | 2.3-6.5 g/cc |
| Minimum d_{pore, 90% volume}**** | 10 nm-50 μm |
| Minimum d_{pore, 50% surface area}***** | 1 nm-15 μm |
| Total Fe (wt %)^{#} | 65-95% |
| Metallic Fe (wt %)^{##} | 46-90% |
| Metallization (%)^{###} | 59-96% |
| Carbon (wt %)^{####} | 0-5% |
| Fe²⁺ (wt %)^{#####} | 1-9% |
| Fe³⁺ (wt %)^{$} | 0.9-25% |
| SiO₂ (wt %)^{$$} | 1-15% |
| Ferrite (wt %, XRD)^{$$$} | 22-97% |
| Wustite (FeO, wt %, XRD)^{$$$$} | 0-13% |
| Goethite (FeOOH, wt %, XRD)^{$$$$$} | 0-23% |
| Cementite (Fe₃C, wt %, XRD)⁺ | <<80% |

*Specific surface area preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EGME) adsorption, electrokinetic analysis of complex-ion adsorption and a Protein Retention (PR) method may be employed to provide results that can be correlated with BET results.

**Actual density preferably determined by helium (He) pycnometry, and more preferably as is set forth in ISO 12154 (the entire disclosure of which is incorporated herein by reference); recognizing that other tests may be employed to provide results that can be correlated with He pycnometry results. Actual density may also be referred to as “true density” or “skeletal density” in the art.

***Apparent density preferably determined by immersion in water, and more preferably as is set forth in ISO 15968 (the entire disclosure of which is incorporated herein by reference); recognizing that other tests may be employed to provide results that can be correlated with He pycnometry results. Porosity may be defined as the ratio of apparent density to actual density:

$$Porosity = \frac{apparent density}{actual density}$$

****d_{pore, 90% volume} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results. d_{pore, 90% volume} is the pore diameter above which 90% of the total pore volume exists.

*****d_{pore, 50% surface area} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results. d_{pore, 50% surface area} is the pore diameter above which 50% of free surface area exists.

#Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can be correlated with dichromate titrimetry.

##Metallic Fe (wt %) preferably determined by iron(III) chloride titrimetry, and more preferably as is set forth in ISO 16878 (the entire disclosure of which is incorporated herein by reference); recognizing that other tests, such as bromine-methanol titimetry, may be employed to provide results that can be correlated with iron(III) chloride titrimetry.

###Metallization (%) preferably determined by the ratio of metallic Fe to total Fe, each as preferably determined by the methods previously described.

####Carbon (wt %) preferably determined by infrared absorption after combustion in an induction furnace, and more preferably as is set forth in ISO 9556 (the entire disclosure of which is incorporated herein by reference); recognizing that other tests, such as various combustion and inert gas fusion techniques, such as are described in ASTM E1019-18 may be employed to provide results that can be correlated with infrared absorption after combustion in an induction furnace.

#####Fe²⁺ (wt %) preferably determined by titrimetry, and more preferably as is set forth in ASTM D3872-05 (the entire disclosure of which is incorporated herein by reference); recognizing that other tests, such as Mossbauer spectroscopy, X-ray absorption spectroscopy, etc., may be employed to provide results that can be correlated with titrimetry.

S Fe³⁺ (wt %) preferably determined by the mass balance relation between and among Total Fe (wt %), Metallic Fe (wt %), Fe²⁺ (wt %) and Fe³⁺ (wt %). Specifically the equality Total Fe (wt %)=Metallic Fe (wt %)+Fe²⁺ (wt %)+Fe³⁺ (wt %) must be true by conservation of mass, so Fe³⁺ (wt %) may be calculated as Fe³⁺ (wt %)=Total Fe (wt %)−Metallic Fe (wt %)−Fe²⁺ (wt %).

$$ SiO₂ (wt %) preferably determined by gravimetric methods, and more preferably as is set forth in ISO 2598-1 (the entire disclosure of which is incorporated herein by reference); recognizing that other tests, such as reduced molybdosilicate spectrophotometric methods, x-ray diffraction (XRD), may be employed to provide results that can be correlated with gravimetric methods. In certain methods, the SiO₂ wt % is not determined directly, but rather the Si concentration (inclusive of neutral and ionic species) is measured, and the SiO₂ wt % is calculated assuming the stoichiometry of SiO₂; that is, a 1:2 molar ratio of Si:O is assumed.

$$$ Ferrite (wt %, XRD) preferably determined by x-ray diffraction (XRD).

$$$$ Wustite (FeO, wt %, XRD) preferably determined by x-ray diffraction (XRD).

$$$$$ Goethite (FeOOH, wt %, XRD) preferably determined by x-ray diffraction (XRD).

+ Cementite (Fe₃C, wt %, XRD) preferably determined by x-ray diffraction (XRD).

Additionally, embodiments of iron materials, including for example embodiments of DRI materials, for use in various embodiments described herein, including as electrode materials, may have one or more of the following properties, features or characteristics, (noting that values from one row or one column may be present with values in different rows or columns) as set forth in Table 2.

TABLE 2

| | | | | |
|---|---|---|---|---|
| Fe total (wt %)^{!} | >60% | >70% | >80% | ~83-94% |
| SiO₂ (wt %)^{!!} | <12% | <7.5% | 1-10% | 1.5-7.5% |
| Al₂O₃ (wt %)^{!!!} | <10% | <5% | 0.2-5% | 0.3-3% |
| MgO (wt %)^{!!!!} | <10% | <5% | 0.1-10% | 0.25-2% |
| CaO (wt %)^{!!!!!} | <10% | <5% | 0.9-10% | 0.75-2.5% |
| TiO₂ (wt %)^{&} | <10% | <2.5% | 0.05-5% | 0.25-1.5% |
| Size (largest | <200 mm | ~50 to ~150 mm | ~2 to ~30 mm | ~4 to ~20 mm |
| cross-sectional | | | | |
| distance, e.g. | | | | |
| for a sphere | | | | |
| the diameter) | | | | |
| Actual Density | ~5 | ~5.8 to ~6.2 | ~4.0 to ~6.5 | <7.8 |
| (g/cm³)^{&&} | | | | |
| Apparent | <7.8 | >5 | >4 | 3.4~3.6 |
| Density | | | | |
| (g/cm³)^{&&&} | | | | |
| Bulk Density | <7 | >1.5 | ~2.4 to ~3.4 | ~1.5 to ~2.0 |
| (kg/m³)^{&&&&} | | | | |
| Porosity | >15% | >50% | ~20% to ~90% | ~50% to ~70% |
| (%)^{&&&&&} | | | | |

! Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can be correlated with dichromate titrimetry.

!! SiO₂ (wt %) preferably determined by gravimetric methods, and more preferably as is set forth in ISO 2598-1 (the entire disclosure of which is incorporated herein by reference); recognizing that other tests, such as reduced molybdosilicate spectrophotometric methods, x-ray diffraction (XRD), may be employed to provide results that can be correlated with gravimetric methods. In certain methods, the SiO₂ wt % is not determined directly, but rather the Si concentration (inclusive of neutral and ionic species) is measured, and the SiO₂ wt % is calculated assuming the stoichiometry of SiO₂; that is, a 1:2 molar ratio of Si:O is assumed.

!!! Al₂O₃ (wt %) preferably determined by flame atomic absorption spectrometric method, and more preferably as is set forth in ISO 4688-1 (the entire disclosure of which is incorporated herein by reference); recognizing that other tests, such as x-ray diffraction (XRD), may be employed to provide results that can be correlated with flame atomic absorption spectrometric method. In certain methods, the Al₂O₃ wt % is not determined directly, but rather the Al concentration (inclusive of neutral and ionic species) is measured, and the Al₂O₃ wt % is calculated assuming the stoichiometry of Al₂O₃; that is, a 2:3 molar ratio of A1:0 is assumed.

!!!! MgO (wt %) preferably determined by flame atomic absorption spectrometric method, and more preferably as is set forth in ISO 10204 (the entire disclosure of which is incorporated herein by reference); recognizing that other tests, such as x-ray diffraction (XRD), may be employed to provide results that can be correlated with flame atomic absorption spectrometric method. In certain methods, the MgO wt % is not determined directly, but rather the Mg concentration (inclusive of neutral and ionic species) is measured, and the MgO wt % is calculated assuming the stoichiometry of MgO; that is, a 1:1 molar ratio of Mg:O is assumed.

!!!!! CaO (wt %) preferably determined by flame atomic absorption spectrometric method, and more preferably as is set forth in ISO 10203 (the entire disclosure of which is incorporated herein by reference); recognizing that other tests, such as x-ray diffraction (XRD), may be employed to provide results that can be correlated with flame atomic absorption spectrometric method. In certain methods, the CaO wt % is not determined directly, but rather the Ca concentration (inclusive of neutral and ionic species) is measured, and the CaO wt % is calculated assuming the stoichiometry of CaO; that is, a 1:1 molar ratio of Ca:O is assumed.

& TiO₂ (wt %) preferably determined by a diantipyrylmethane spectrophotometric method, and more preferably as is set forth in ISO 4691 (the entire disclosure of which is incorporated herein by reference); recognizing that other tests, such as x-ray diffraction (XRD), may be employed to provide results that can be correlated with the diantipyrylmethane spectrophotometric method method. In certain methods, the TiO₂ wt % is not determined directly, but rather the Ti concentration (inclusive of neutral and ionic species) is measured, and the TiO₂ wt % is calculated assuming the stoichiometry of TiO₂; that is, a 1:2 molar ratio of Ti:O is assumed.

&& Actual density preferably determined by helium (He) pycnometry, and more preferably as is set forth in ISO 12154 (the entire disclosure of which is incorporated herein by reference); recognizing that other tests may be employed to provide results that can be correlated with He pycnometry results. Actual density may also be referred to as “true density” or “skeletal density” in the art.

&&& Apparent density preferably determined by immersion in water, and more preferably as is set forth in ISO 15968 (the entire disclosure of which is incorporated herein by reference); recognizing that other tests may be employed to provide results that can be correlated with He pycnometry results.

&&&& Bulk Density (kg/m³) preferably determined by measuring the mass of a test portion introduced into a container of known volume until its surface is level, and more preferably as is set forth in Method 2 of ISO 3852 (the entire disclosure of which is incorporated herein by reference); recognizing that other tests may be employed to provide results that can be correlated with the massing method.

&&&&& Porosity determined preferably by the ratio of the apparent density to the actual density:

$$Porosity = \frac{apparent density}{actual density}$$

The properties set forth in Table 1, may also be present in embodiments with, in addition to, or instead of the properties in Table 2. Greater and lesser values for these properties may also be present in various embodiments.

In embodiments the specific surface area for the pellets can be from about 0.05 m²/g to about 35 m²/g, from about 0.1 m²/g to about 5 m²/g, from about 0.5 m²/g to about 10 m²/g, from about 0.2 m²/g to about 5 m²/g, from about 1 m²/g to about 5 m²/g, from about 1 m²/g to about 20 m²/g, greater than about 1 m²/g, greater than about 2 m²/g, less than about 5 m²/g, less than about 15 m²/g, less than about 20 m²/g, and combinations and variations of these, as well as greater and smaller values.

In general, iron ore pellets are produced by crushing, grinding or milling of iron ore to a fine powdery form, which is then concentrated by removing impurity phases (so called “gangue”) which are liberated by the grinding operation. In general, as the ore is ground to finer (smaller) particle sizes, the purity of the resulting concentrate is increased. The concentrate is then formed into a pellet by a pelletizing or balling process (using, for example, a drum or disk pelletizer). In general, greater energy input is required to produce higher purity ore pellets. Iron ore pellets are commonly marketed or sold under two principal categories: Blast Furnace (BF) grade pellets and Direct Reduction (DR Grade) (also sometimes referred to as Electric Arc Furnace (EAF) Grade) with the principal distinction being the content of SiO₂ and other impurity phases being higher in the BF grade pellets relative to DR Grade pellets. Typical key specifications for a DR Grade pellet or feedstock are a total Fe content by mass percentage in the range of 63-69 wt % such as 67 wt % and a SiO₂ content by mass percentage of less than 3 wt % such as 1 wt %. Typical key specifications for a BF grade pellet or feedstock are a total Fe content by mass percentage in the range of 60-67 wt % such as 63 wt % and a SiO₂ content by mass percentage in the range of 2-8 wt % such as 4 wt %.

In certain embodiments the DRI may be produced by the reduction of a “Blast Furnace” pellet, in which case the resulting DRI may have material properties as described in Table 3 below. The use of reduced BF grade DRI may be advantageous due to the lesser input energy required to produce the pellet, which translates to a lower cost of the finished material.

TABLE 3

| Material Property | Embodiment Range |
|---|---|
| Specific surface area* | 0.21-25 m²/g |
| Actual density** | 5.5-6.7 g/cc |
| Apparent density*** | 3.1-4.8 g/cc |
| Minimum d_{pore, 90% volume}**** | 50 nm-50 μm |
| Minimum d_{pore, 50% surface area}***** | 1 nm-10 μm |
| Total Fe (wt %)^{#} | 81.8-89.2% |
| Metallic Fe (wt %)^{##} | 68.7-83.2% |
| Metallization (%)^{###} | 84-95% |
| Carbon (wt %)^{####} | 0.03-0.35% |
| Fe²⁺ (wt %)^{#####} | 2-8.7% |
| Fe³⁺ (wt %)^{$} | 0.9-5.2% |
| SiO₂ (wt %)^{$$} | 3-7% |
| Ferrite (wt %, XRD)^{$$$} | 80-96% |
| Wustite (FeO, wt %, XRD)^{$$$$} | 2-13% |
| Goethite (FeOOH, wt %, XRD)^{$$$$$} | 0-11% |
| Cementite (Fe₃C, wt %, XRD)⁺ | 0-80% |

*Specific surface area preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EGME) adsorption, electrokinetic analysis of complex-ion adsorption and a Protein Retention (PR) method may be employed to provide results that can be correlated with BET results.

**Actual density preferably determined by helium (He) pycnometry, and more preferably as is set forth in ISO 12154 (the entire disclosure of which is incorporated herein by reference); recognizing that other tests may be employed to provide results that can be correlated with He pycnometry results. Actual density may also be referred to as “true density” or “skeletal density” in the art.

***Apparent density preferably determined by immersion in water, and more preferably as is set forth in ISO 15968 (the entire disclosure of which is incorporated herein by reference); recognizing that other tests may be employed to provide results that can be correlated with He pycnometry results. Porosity may be defined as the ratio of apparent density to actual density:

$$Porosity = \frac{apparent density}{actual density}$$

****d_{pore, 90% volume} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results. d_{pore, 90% volume} is the pore diameter above which 90% of the total pore volume exists.

*****d_{pore, 50% surface area} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results. d_{pore, 50% surface area} is the pore diameter above which 50% of free surface area exists.

#Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can be correlated with dichromate titrimetry.

##Metallic Fe (wt %) preferably determined by iron(III) chloride titrimetry, and more preferably as is set forth in ISO 16878 (the entire disclosure of which is incorporated herein by reference); recognizing that other tests, such as bromine-methanol titimetry, may be employed to provide results that can be correlated with iron(III) chloride titrimetry.

###Metallization (%) preferably determined by the ratio of metallic Fe to total Fe, each as preferably determined by the methods previously described.

####Carbon (wt %) preferably determined by infrared absorption after combustion in an induction furnace, and more preferably as is set forth in ISO 9556 (the entire disclosure of which is incorporated herein by reference); recognizing that other tests, such as various combustion and inert gas fusion techniques, such as are described in ASTM E1019-18 may be employed to provide results that can be correlated with infrared absorption after combustion in an induction furnace.

#####Fe²⁺ (wt %) preferably determined by titrimetry, and more preferably as is set forth in ASTM D3872-05 (the entire disclosure of which is incorporated herein by reference); recognizing that other tests, such as Mossbauer spectroscopy, X-ray absorption spectroscopy, etc., may be employed to provide results that can be correlated with titrimetry.

Fe³⁺ (wt %) preferably determined by the mass balance relation between and among Total Fe (wt %), Metallic Fe (wt %), Fe²⁺ (wt %) and Fe³⁺ (wt %). Specifically the equality Total Fe (wt %)=Metallic Fe (wt %)+Fe²⁺ (wt %)+Fe³⁺ (wt %) must be true by conservation of mass, so Fe³⁺ (wt %) may be calculated as Fe³⁺ (wt %)=Total Fe (wt %)−Metallic Fe (wt %)−Fe²⁺ (wt %).

$$ SiO₂ (wt %) preferably determined by gravimetric methods, and more preferably as is set forth in ISO 2598-1 (the entire disclosure of which is incorporated herein by reference); recognizing that other tests, such as reduced molybdosilicate spectrophotometric methods, x-ray diffraction (XRD), may be employed to provide results that can be correlated with gravimetric methods. In certain methods, the SiO₂ wt % is not determined directly, but rather the Si concentration (inclusive of neutral and ionic species) is measured, and the SiO₂ wt % is calculated assuming the stoichiometry of SiO₂; that is, a 1:2 molar ratio of Si:O is assumed.

$$$ Ferrite (wt %, XRD) preferably determined by x-ray diffraction (XRD).

$$$$ Wustite (FeO, wt %, XRD) preferably determined by x-ray diffraction (XRD).

$$$$$ Goethite (FeOOH, wt %, XRD) preferably determined by x-ray diffraction (XRD).

+ Cementite (Fe₃C, wt %, XRD) preferably determined by x-ray diffraction (XRD).

The properties set forth in Table 3, may also be present in embodiments with, in addition to, or instead of the properties in Tables 1 and/or 2. Greater and lesser values for these properties may also be present in various embodiments.

In certain embodiments the DRI may be produced by the reduction of a DR Grade pellet, in which case the resulting DRI may have material properties as described in Table 4 below. The use of reduced DR grade DRI may be advantageous due to the higher Fe content in the pellet which increases the energy density of the battery.

TABLE 4

| Material Property | Embodiment Range |
|---|---|
| Specific surface area* | 0.1-0.7 m²/g as received or |
| | 0.19-25 m²/g after performing |
| | a pre-charge formation step |
| Actual density** | 4.6-7.1 g/cc |
| Apparent density*** | 2.3-5.7 g/cc |
| Minimum d_{pore, 90% volume}**** | 50 nm-50 μm |
| Minimum d_{pore, 50% surface area}***** | 1 nm-10 μm |
| Total Fe (wt %)^{#} | 80-94% |
| Metallic Fe (wt %)^{##} | 64-94% |
| Metallization (%)^{###} | 80-100% |
| Carbon (wt %)^{####} | 0-5% |
| Fe²⁺ (wt %)^{#####} | 0-8% |
| Fe³⁺ (wt %)^{$} | 0-10% |
| SiO₂ (wt %)^{$$} | 1-4% |
| Ferrite (wt %, XRD)^{$$$} | 22-80% |
| Wustite (FeO, wt %, XRD)^{$$$$} | 0-13% |
| Goethite (FeOOH, wt %, XRD)^{$$$$$} | 0-23% |
| Cementite (Fe₃C, wt %, XRD)⁺ | <<80% |

*Specific surface area preferably determined by the Brunauer-Emmett-Teller adsorption method (“BET”), and more preferably as the BET is set forth in ISO 9277 (the entire disclosure of which is incorporated herein by reference); recognizing that other tests, such as methylene blue (MB) staining, ethylene glycol monoethyl ether (EEIME) adsorption, electrokinetic analysis of complex-ion adsorption and a Protein Retention (PR) method may be employed to provide results that can be correlated with BET results.

**Actual density preferably determined by helium (He) pycnometry, and more preferably as is set forth in ISO 12154 (the entire disclosure of which is incorporated herein by reference); recognizing that other tests may be employed to provide results that can be correlated with He pycnometry results. Actual density may also be referred to as “true density” or “skeletal density” in the art.

***Apparent density preferably determined by immersion in water, and more preferably as is set forth in ISO 15968 (the entire disclosure of which is incorporated herein by reference); recognizing that other tests may be employed to provide results that can be correlated with He pycnometry results. Porosity may be defined as the ratio of apparent density to actual density:

$$Porosity = \frac{apparent density}{actual density}$$

****d_{pore, 90% volume} preferably determined by mercury (Hg) intrusion porosimetry, and more preferably as is set forth in ISO 15901-1 (the entire disclosure of which is incorporated herein by reference); recognizing that other tests, such as gas adsorption, may be employed to provide results that can be correlated with Hg intrusion results. d_{pore, 90% volume} is the pore diameter above which 90% of the total pore volume exists.

*****d_{pore, 50% surface area} preferably determined by mercury (Hg) intrusion porosimetry, and more preferably as is set forth in ISO 15901-1 (the entire disclosure of which is incorporated herein by reference); recognizing that other tests, such as gas adsorption, fray be employed to provide results that can be correlated with Hg intrusion results. d_{pore, 50% surface area} is the pore diameter above which 50% of free surface area exists.

#Total Fe (wt %) preferably determined by dichromate titrimetry, and more preferably as is set forth in ASTM E246-10 (the entire disclosure of which is incorporated herein by reference); recognizing that other tests, such as titrimetry after tin(II) chloride reduction, titrimetry after titanium(III) chloride reduction, inductively coupled plasma (ICP) spectrometry, may be employed to provide results that can be correlated with dichromate titrimetry.

##Metallic Fe (wt %) preferably determined by iron(III) chloride titrimetry, and more preferably as is set forth in ISO 16878 (the entire disclosure of which is incorporated herein by reference); recognizing that other tests, such as bromine-methanol titimetry, may be employed to provide results that can be correlated with iron(III) chloride titrimetry.

###Metallization (%) preferably determined by the ratio of metallic Fe to total Fe, each as preferably determined by the methods previously described.

####Carbon (wt %) preferably determined by infrared absorption after combustion in an induction furnace, and more preferably as is set forth in ISO 9556 (the entire disclosure of which is incorporated herein by reference); recognizing that other tests, such as various combustion and inert gas fusion techniques, such as are described in ASTM E1019-18 may be employed to provide results that can be correlated with infrared absorption after combustion in an induction furnace.

#####Fe²⁺ (wt %) preferably determined by titrimetry, and more preferably as is set forth in ASTM D3872-05 (the entire disclosure of which is incorporated herein by reference); recognizing that other tests, such as Mossbauer spectroscopy, X-ray absorption spectroscopy, etc., may be employed to provide results that can be correlated with titrimetry.

$ Fe³⁺ (wt %) preferably determined by the mass balance relation between and among Total Fe (wt %), Metallic Fe (wt %), Fe²⁺ (wt %) and Fe³⁺ (wt %). Specifically the equality Total Fe (wt %)=Metallic Fe (wt %)+Fe²⁺ (wt %)+Fe³⁺ (wt %) must be true by conservation of mass, so Fe³⁺ (wt %) may be calculated as Fe³⁺ (wt %)=Total Fe (wt %) −Metallic Fe (wt %)−Fe²⁺ (wt %).

$$ SiO₂ (wt %) preferably determined by gravimetric methods, and more preferably as is set forth in ISO 2598-1 (the entire disclosure of which is incorporated herein by reference); recognizing that other tests, such as reduced molybdosilicate spectrophotometric methods, x-ray diffraction (XRD), may be employed to provide results that can be correlated with gravimetric methods. In certain methods, the SiO₂ wt % is not determined directly, but rather the Si concentration (inclusive of neutral and ionic species) is measured, and the SiO₂ wt % is calculated assuming the stoichiometry of SiO₂; that is, a 1:2 molar ratio of Si:O is assumed.

$$$ Ferrite (wt %, XRD) preferably determined by x-ray diffraction (XRD).

$$$$ Wustite (FeO, wt %, XRD) preferably determined by x-ray diffraction (XRD).

$$$$$ Goethite (FeOOH, wt %, XRD) preferably determined by x-ray diffraction (XRD).

+ Cementite (Fe₃C, wt %, XRD) preferably determined by x-ray diffraction (XRD).

The properties set forth in Table 4, may also be present in embodiments with, in addition to, or instead of the properties in Tables 1, 2, and/or 3. Greater and lesser values for these properties may also be present in various embodiments.

An electrochemical cell, such as a battery, stores electrochemical energy by using a difference in electrochemical potential generating a voltage difference between the positive and negative electrodes. This voltage difference produces an electric current if the electrodes are connected by a conductive element. In a battery, the negative electrode and positive electrode are connected by external and internal conductive elements in parallel. Generally, the external element conducts electrons, and the internal element (electrolyte) conducts ions. Because a charge imbalance cannot be sustained between the negative electrode and positive electrode, these two flow streams must supply ions and electrons at the same rate. In operation, the electronic current can be used to drive an external device. A rechargeable battery can be recharged by applying an opposing voltage difference that drives an electronic current and ionic current flowing in an opposite direction as that of a discharging battery in service.

In general, but particularly for long-duration storage applications, electrodes and electrode materials that are low-cost and simple to manufacture are desired. Manufacturing and/or fabrication processes may be evaluated and selected based on multiple criteria including capital cost, material throughput, operating costs, number of unit operations, number of material transfers, number of material handling steps, required energy input, amounts of generated waste products and/or by-products, etc.

An electrochemical cell, such as a battery, stores electrochemical energy by using a difference in electrochemical potential generating a voltage difference between the positive and negative electrodes. This voltage difference produces an electric current if the electrodes are connected by a conductive element. In a battery, the negative electrode and positive electrode are connected by external and internal conductive elements in parallel. Generally, the external element conducts electrons, and the internal element (electrolyte) conducts ions. Because a charge imbalance cannot be sustained between the negative electrode and positive electrode, these two flow streams must supply ions and electrons at the same rate. In operation, the electronic current can be used to drive an external device. A rechargeable battery can be recharged by applying an opposing voltage difference that drives an electronic current and ionic current flowing in an opposite direction as that of a discharging battery in service.

Iron is an ideal electrode material due to its low cost, very high production volumes, recyclability, and high theoretical and practical energy storage capacity in terms of energy stored per unit mass of material. The low material cost and high energy storage result in a large amount of energy stored per unit amount of raw material. These factors, especially cost per unit amount of energy stored and production volumes, are crucial for long duration, grid-scale energy storage applications which are highly cost sensitive and require very large amounts of energy to be stored. Iron is also intrinsically electronically conductive, which can simplify the problems associated with getting charge into and out of battery electrode materials encountered in many battery systems.

A central problem in the design of all battery electrodes is to enable transport of electrons and ions to and from reaction sites. Generally, this requires interconnected porosity for the electrolyte to transport ions, and a percolating, electrically conductive network. In the iron battery electrodes discussed herein, porous particulate iron provides the porosity which is filled by a caustic electrolyte. The percolating, electrically conductive network may be provided by the iron material itself, with the conductive, metallurgical bonds formed by thermomechanical processing. The metallurgical bonds may occur through a combination of solid state diffusion and bonding due to mechanically-induced plasticity. Iron, specifically, forms discharge products with a much higher volume the iron metal itself. Thus, in order to accommodate the microscopic formation of a large amount of discharge product, iron electrodes generally needed to have a large amount (>40%, with much higher amounts being preferred) of microscopic porosity. A porous particulate iron material satisfies the requirements of being intrinsically conductive and possessing a higher amount of microporosity. The methods described herein describe how to effectively bond these materials together such that a high performance electrode is obtained at low cost.

The ideal electrical conductor for the iron electrode is the iron itself, as its use as a conductor involves no extra parts, assembly, bonding, or other design elements that add cost and complexity to the material. A central problem with forming metallurgical bonds between the porous particulate iron material is that many techniques used to bond these metals are either not well-suited for the bonding of porous materials or cause densification of the microporosity, or have other associated difficulties. For example, arc welding can cause porous iron materials to evaporate, sintering causes densification globally and therefore a loss of microporosity, and mechanical compaction at low temperatures results in densification of the materials and poor electrical connection due to lack of interdiffusion between particles. The problems with low temperature mechanical compaction grow larger as the particle size of the particulate material increases due to the increased tendency for the material to flow/loosen the compaction. High temperature thermomechanical processing is uniquely suited to bond porous particulate iron particles together for battery applications because the stress concentration at the contact points between particles permits localization of the deformation (and thus the bonding) at the contact points between the particles while simultaneously allowing a metallurgical bond to occur. The localized deformation avoids loss of microporosity away from the contact points between particles.

Some forms of high temperature thermomechanical processing are already used at large scales, including uniaxial hot pressing, hot briquetting, and hot isostatic pressing.

In general, high temperature thermomechanical processing involves the simultaneous application of high temperatures and pressures to a material in order to deform and/or consolidate the material. In this context, the high temperature and pressure are used to achieve metallurgical bonding between porous particulate iron materials. The process conditions are described below in Table 5 for a representative embodiment, along with ranges of the process parameters.

TABLE 5

| Process parameter | Suggested Ranges | Comments and guidance |
|---|---|---|
| Deformation Temperature, ° C. | 300-1000 | High temperatures lower |
| | | yield stresses and increase |
| | | solid state diffusion, but result |
| | | in higher capital cost, tool |
| | | wear, and more difficulty |
| | | cooling parts. |
| Pressure, MPa | 0.1-200 MPa | The required pressure can |
| | | vary greatly depending on the |
| | | initial porosity of the |
| | | material, the type of |
| | | compaction used, and the |
| | | material composition. |
| | | Preferred ranges may often be |
| | | closer to 1-100 MPa. |
| Method of loading | Uniaxial | Uniaxial, biaxial, triaxial, |
| | | isostatic, or with rollers |
| | | are all possible. |
| Timescale for deformation | Depends on production | Some techniques, like hot |
| | technique | isostatic pressing, are suited |
| | | for deformation times of |
| | | minutes to hours, whereas |
| | | some techniques, like roll- |
| | | compaction based techniques, |
| | | have deformation times of |
| | | seconds to minutes. |

Similarly, a range material inputs are possible. These material inputs generally inherit their material compositions and properties from the processing techniques used for their production. For example, direct reduced iron materials will generally have porosities within the particles between 50 and 70% by volume, and have iron contents >85 wt. %. High purities are generally preferred for more consistent and higher performance electrodes. The porous particulate iron material should have a moderately high specific surface area, with values >0.003 m²/g preferred, and high values being preferred up to a certain extent. Very high surface areas may be too reactive during both processing and use, with specific surface areas >3 m²/g being too high. By contrast, sponge irons used for powder metallurgical automotive part production may have much higher purities, but may be substantially less porous. In general, an electrode material fabricated by the methods described herein may result in satisfactory performance when the total microporosity contained in the final fabricated part is >50%. This may be derived from the microporosity with the particles fed into a high temperature thermomechanical process, or may arise from a combination of microporosity within the particles and microporosity that emerges from the creation of bonds between the particles.

Guidance for Adjustment of Process Parameters Based on Input Properties of the Materials and Process Changes.

Due to the variety of possible mechanical properties achievable with porous particulate iron materials and how these properties can vary with thermomechanical treatment, it will be appreciated by one skilled in the art that the pressures and temperature ranges described herein may need to be modified based on the specific material used. Some guidance is given to herein to assist in process modification. In cases where a porous particulate iron contains a hardening phase or element, such as carbon, the pressures needed may be higher than described here in order to overcome the increased yield stress. The pressure should roughly scale with the yield stress of the material and/or indentation hardness of the material at the processing temperature. Similarly, porous particulate iron materials with lower porosity may require higher stresses to consolidate.

Preferred Compact Morphologies.

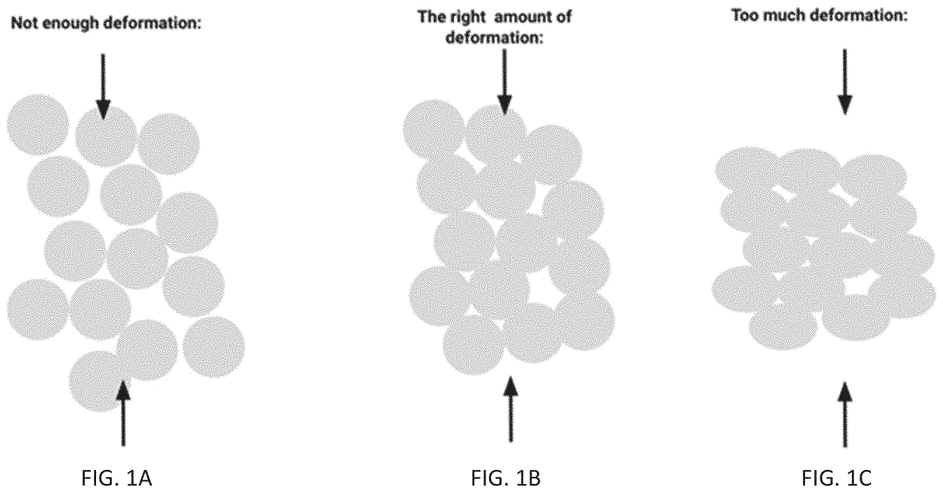

The deformation required for sufficient interparticle bonding is a function of the type of input material used. For material that is input as comparatively large particles (>1 mm), the microporosity created by bonding the particles together may be negligible relative to the microporosity within the particles. This is the case, for example, for a Direct Reduced Iron material. In this case, in order to maintain sufficient porosity within the material, the compaction process may be controlled such that the volumetric reduction in porosity is sufficiently low that the material maintains >50 vol. % microporosity within the particles after the compaction process. To first order, this may be calculated from basic volume conservations and the volumetric engineering strain applied to the material. Input materials with higher initial porosity within the particles may thus accommodate larger deformations while still maintaining >50 vol. % microporosity within the particles. In many cases, the particles will not have sufficient initial porosity that one desires the particles to undergo extensive bulk deformation. In cases where extensive bulk deformation is not desirable, the deformation may take place only at the contacts by suitable adjustment of the process, as schematized in FIGS. 1A, 1B, and 1C.

Inert Atmosphere Strongly Preferred.

In many cases, the porous particulate iron may be thermally insulating when handled as a bulk particulate. Preheating the material in an apparatus designed to evenly heat thermally insulating materials (such as a heated kiln or a blender) may be preferred. In other instances, the porous particulate iron may be produced using a high temperature method and the already-hot material may be fed into the compaction apparatus. Such heating and feeding devices may contain substantially non-oxidizing atmospheres.

In many cases, the high surface area of the porous particulate iron permit undesirable oxidation if the material is exposed to oxygen or other oxidizing agents at elevated temperatures. As such, a non-oxidizing atmosphere (e.g., an inert or reducing atmosphere) may be preferred during any parts of the process occurring at elevated temperatures, and the fabricated parts may be usefully cooled to temperatures where reactions are slower (e.g., below 100° C.) before being exposed to oxygen or other oxidizing agents. In some instances, the material may be usefully passivated by exposure to small amounts of oxygen before exposure to large amounts of oxygen occurs. It should further be noted that the electrical connections between the particles should also serve as thermal connections between the particles. Thus, the compacts may be effectively convectively cooled from a single side after fabrication (e.g., by passage under a fan), despite single-sided convection not being a useful cooling technique for bulk particulate materials that are not placed in thermal communication with one another. Thus, in some embodiments, parts may be fabricated in an inert or reducing atmosphere, hauled off on a belt after fabrication, and cooled via convention while remaining under a substantially non-oxidizing atmosphere. Passivation may occur at the same time as cooling occurs, or after cooling occurs. In some embodiments, the fabricated compacts may be discharged hot into silos or other containers filled with a substantially non-oxidizing atmosphere for cooling and potentially passivation.

In some instances, prevention of oxidation during or after high temperature thermomechanical processing may not be possible to the extent desired. In such circumstances, the oxidation may be removed from these surfaces by suitable means after formation of the electrode. For example, in some embodiments, the surface oxides formed during or after processing may be reduced electrochemically in the battery system prior to or during cycling. In some embodiments, the surface oxides formed during or after processing may be reduced thermochemically in a reducing gas stream prior to incorporation into the battery system. In some embodiments, the surface oxides may be reduced chemically by introduction of a suitable reducing solution such as an acid. Suitable acids for reduction of surface oxides of iron may include those used for etching or pickling of steels including solutions containing nitric, sulfuric, and acetic acids.

The high temperature thermomechanical processing may be performed by suitable applications. In this way, the pressure and/or heat in various embodiments may be applied by one or more of the following process technologies: Hot Isostatic Pressing (HIP), uniaxial hot pressing, hot roll compaction (which may be uniaxial or biaxial), hot briquetting (which in some embodiments takes place with rolls and in other cases by uniaxial compaction), or hot forging. In what follows, the specific methods for fabricating geometries suitable for use as battery electrodes are discussed for each processing technique, with a specific focus on electrodes suitable for long duration energy storage.

Hot isostatic pressing may be used to economically fabricate large billets of material to precise levels of compaction via suitable selection of time-temperature-pressure schedules. The application of HIP, in this circumstance differs in that full or close-to-full densification is not the goal, but rather consolidation of material in an economical manner. In some embodiments, the electrode shape is built into the can used to consolidate the material, and the output of the HIP process results in a useful electrode. In some embodiments, a very large can is fabricated in order to reduce the costs of can fabrication, and electrodes are cut from the billet that results from the HIP processing. The temperature and pressure conditions listed above may be used as a starting point to tune a HIP process to a given material and electrode application.

Uniaxial hot pressing may be used to fabricate large billets when low compaction pressures are needed. In many cases, the compaction pressures needed are much lower than in typical hot pressing applications, as are the temperatures needed. Thus, the unit costs of hot pressing may be substantially reduced relative to typical applications. In some embodiments, a steel hot press may be inserted, material gravimetrically fed into the press, and the material may be pressed automatically. This process may resemble uniaxial hot pressing in terms of the size of the articles produced, but may resemble hot briquetting processing in terms of the parts produced per unit time and the timescale necessary for pressing. In some embodiments, the particulate material may be consolidated at a high rate and for a very short time such that the hot uniaxial compaction process most resembles a hot forging.

Consolidation Techniques

Thermal Spraying

Thermal spraying may be used to fabricate large billets from particles. The bonding, density, and other properties of the resulting compact may be adjusted advantageously by controlling process parameters such as the velocity, temperature, and direction, and deposition rate of the sprayed particles. In one embodiment, porous particulate iron particles could be sprayed onto a substrate. The substrate may serve as a current collector or structural reinforcement for the resultant billet. In another embodiment, bonding particles could be sprayed along with porous particulate iron particles, or onto a prepared bed of DRI particles, in order to bond the porous particulate iron particles together.

Additive Manufacturing (e.g., Direct Metal Laser Sintering (DMLS)) with DRI Laser Sintering or Laser Melting may be used to bond porous particulate iron particles to one another, thereby forming or adding to a larger billet. In some embodiments, a layer-wise process may be used, wherein one or more layers of particulate material is deposited and laser energy is applied to the entire layer or to selected regions within the layer. In some embodiments, one or more galvanometers, positioning systems, and/or optical components may be used to direct the laser energy onto the desired regions. In some embodiments, other directed energy deposition strategies may be used in place of, or together with, a laser, such as Digital Light Processing (DLP) projection technology, microwave radiation, resistive heating and electric arc heating. Such methods may also be used for local modification of one or more regions on an existing billet.

Welding Techniques.

In some embodiments, one or more welding technologies may be used to connect or consolidate porous particulate iron particles, for example by forming a metallurgical bond between particles of porous particulate iron, thereby joining them together into a mechanically and/or electrically contiguous billet. Such methods include alternating current (AC) resistance welding, direct current (DC) resistance welding, arc welding, explosive welding, forge welding, high frequency (HF) welding, capacitive discharge welding, friction stir welding, and other traditional fusion welding techniques. In some embodiments a filler material and/or flux material may be used, for example to enhance bonding or reduce or remove oxidation tendency at the welds.

Ultrasonic Compaction Vibrations, including ultrasonic vibrations, may be used as a way to heat or mechanically agitate the porous particulate iron, either alone or in conjunction with other heating and agitation methods herein. Vibrations may be used in combination with other pressing processes, to aid in the consistency, speed, bonding strength, or other aspects of the compaction process.

Making a larger or simpler compact, and slicing or post-machining it: In some embodiments, the billet formed may be larger than, or otherwise different from, the desired geometry of an electrode or component thereof, and the billet may be subsequently sectioned, machined, assembled, or otherwise processed into suitable intermediate or end-use shapes. This may be advantageous in achieving low cost and high throughput when forming the billet by adjusting the form of the billet to suit the compaction methods used. Such a billet may be formed using any one or more suitable compaction methods. The initial form may be similar to, or substantially different from, the desired form. In some embodiments, the initial form may contain some quantity of a desired geometry extended in one or more axes, for example with a 2D profile extended in a third dimension, such that cutting the billet into slices yields the desired form. In other embodiments, a billet may require only localized machining or reshaping to achieve the desired form. This sectioning or shaping may be achieved through the use of one or more cutting, splitting, milling or grinding processes. Such processes may include cutting by waterjet, plasma, laser, oxy-fuel torch, and/or mechanical sawing. The billet material may also be slit, sheared, scored, snapped, bent, or formed into an advantageous geometry. The resulting geometry may represent one or more complete electrodes, or a component of an electrode, one or more of which may be assembled along with other components to form an electrode.

Cold Compaction. In some embodiments the consolidation processes described above, especially roll compaction, isostatic pressing, and uniaxial pressing, may be conducted at room temperature, or at a temperature substantially lower than what is typically used in industry for a given compaction process. Such low temperature billet formation is advantageous in that it reduces or eliminates much of the complexity and cost associated with heating material to elevated temperatures and the equipment necessary for high temperature processing. This low temperature processing may be achieved by appropriate tuning of process parameters, such as time or pressure, and through the formulation or other modification of the porous particulate iron. In some embodiments the composition, microstructure, and/or shape of the iron particles may be formulated to facilitate billet formation at lower temperatures. In some embodiments, a physical, chemical, or other surface treatment may be used to facilitate billet formation at lower temperatures.

As an alternative to cold bonding, cold extrusion can be used to form shapes designed to enhance the performance of the electrode by increasing its available surface area. Cold extrusion may be used to create a 3D tortuous block from the ore slurry, which travels through the DRI reactor as a block and reduces into iron blocks of high surface areas. The shape can include spheres, cylinders, or any 3D shapes that would flow freely in a reduction reactor. The surface area can be increased further with holes or added surface texture such as dimples and ribs. In some embodiments, the binder and other additive material that will burn off at high temperature during reduction may be used to enhance internal porosity;

Alternatively, cold extrusion may be used to form the shape described above after reduction of the iron oxide into iron.

Another method to create complex 3D shapes with added porosity is to dry a slurry of the iron ore using techniques common in the ceramics industry, such as plaster cast, mold casting, which are then cured in high temperature ovens. In other embodiments, such techniques can be used with the reduced iron.

Non-Uniform Compaction Temperatures.

In some embodiments, one or more regions of the material may be at one or more different temperatures, potentially with a large range of hotter and colder temperatures at different points in space and time. This nonuniform temperature profile may be used to modify the behavior and properties of the porous iron material in advantageous ways to promote favorable bonding, porosity, deformation, or other characteristics of interest. In some embodiments, the material may be hottest on the faces of a planar electrode, thereby creating the greatest strength at the edges, while leaving the interior only lightly deformed. The resultant electrode would exhibit a useful combination of high flexural strength from deformation close to the hot faces while preserving porosity in the colder interior away from the faces.

Combining multiple billets, adding particles to existing billets. In some embodiments, compaction and bonding methods, including those described herein as methods to consolidate porous particulate iron, may also be applied to billets thereof, or some combination of porous particulate iron and billets thereof. Such methods may be used, for example, to join one or more billets to another, or to join additional porous particulate iron to an existing billet. Any such heating, pressing, welding, spraying, or other techniques may be used one or more times in various sequences.

Form of the Electrode or Billet.

Any billet or electrode must be of sufficient mechanical and electrical robustness to avoid damage throughout its life cycle, including any manufacturing, assembly, transportation, operation, servicing, and disposal procedures. The geometric form of the electrode or billet may be chosen in such a way as to promote the robustness thereof. In some embodiments, the dimensions, thickness, and aspect ratio of a billet or electrode may be chosen such that the geometry will be sufficiently robust against various forms of breakage or degradation.

Channeled Electrodes with Enhanced Performance Characteristics.

In general, for many battery electrodes and especially for thick format electrodes, ionic transport can limit rate capability of the electrode. In hot compacted and pressed and sintered electrodes specifically, particles can deform and form a dense structure, resulting in reduced macroporosity for ionic transport through the thickness of the anode. Further, the macroporosity that results can have high tortuously and unfavorable alignment relative to the direction of ionic transport. There thus exists a need for equipment designs and processing methods that enhance ionic transport through the thickness of the electrode. Further, in some hot rolling processes for porous electrodes, it may be difficult to provide a surface to push material against to grip the electrode if a low degree of compaction is desired. Protruding features may allow for mechanical engagement of the roller with the material such that the rolling process can occur at lower forces. Textured or channeled electrodes with variable degrees of compaction and/or metallurgical bonding across the electrode area may usefully exhibit enhanced mechanical robustness and electrical conduction characteristics.

Variable-thickness channels and other similar patterns of designed shape in metallurgically bonded electrodes may be formed by various methods.

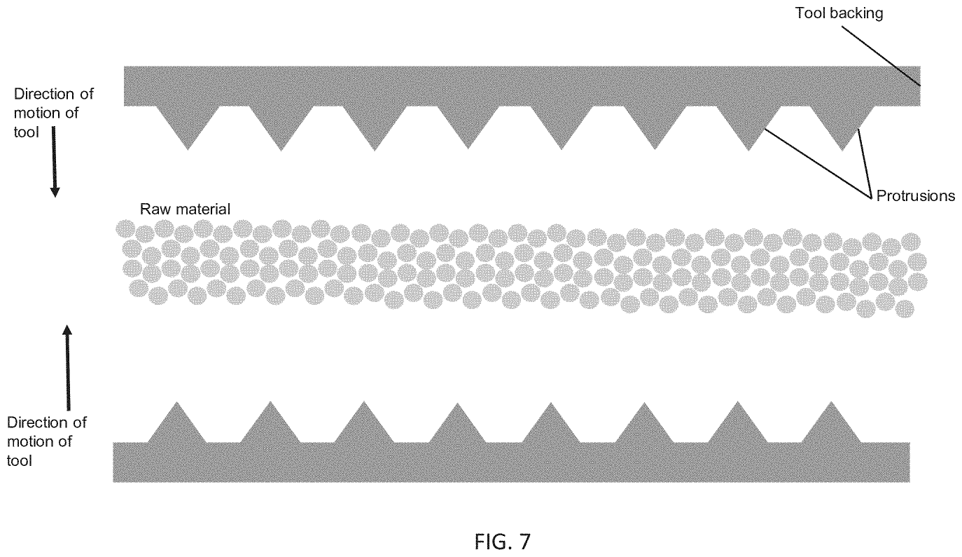

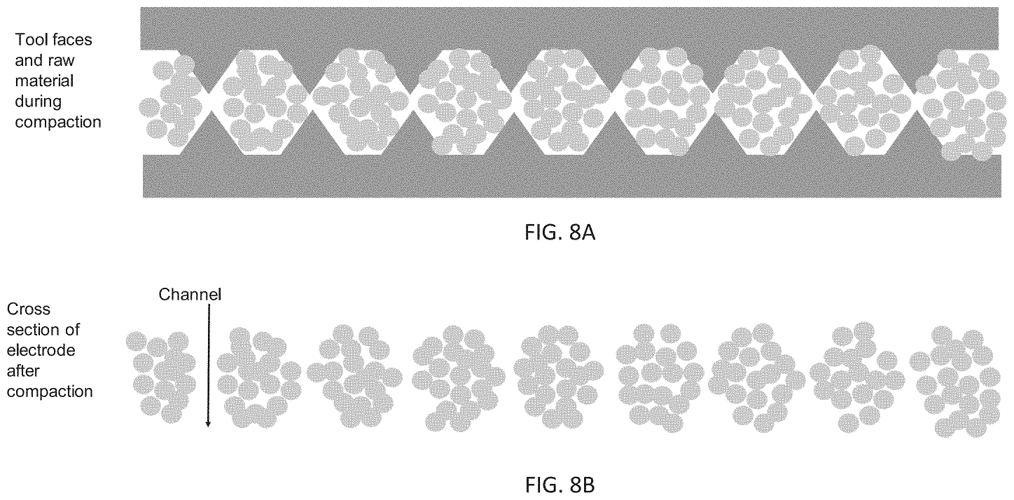

The tooling to produce the electrodes may be patterned with a plurality of protruding features (spikes, cones, rods, or similar) which result in macroporosity that extends through the thickness of the electrode by excluding material during the pressing process. This tooling may then be used to press, roll, or otherwise mechanically fabricate an electrode. The electrode may be pressed for the purpose of subsequent sintering, the tool may remain with the electrode for at least a part of the sintering process, or the toll may be used to press (in a hot or cold pressing action) an electrode for subsequent use. In some embodiments, the area fraction and spacing of the protruding features may be optimally calculated to provide the optimal compromise of rate capability and areal capacity for the specific applications. In some embodiments, a roll compaction process may be used. The roll compaction process may utilize high temperatures above 300° C. to metallurgically bond an electrode material together. The input material for electrode fabrication may be iron or a derivative thereof. The electrode material may more specifically be a sponge iron, direct reduced iron, or any other similar, highly porous metallic iron material. Conical protrusions may be used to ensure the proper material flow around the protrusions and minimize tool wear. The angle of the protrusions may be selected or otherwise optimized to provide a surface to push against. FIGS. 7, 8A and 8B illustrate examples of tooling and pressing operations to form channeled electrodes according to various embodiments.

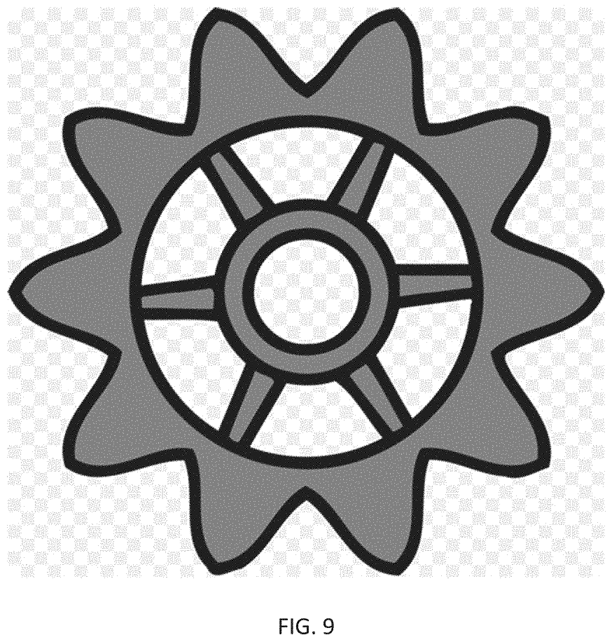

A roller with teeth similar to below can be used to make a channeled pattern in the electrode. FIG. 9 illustrates an example of a roller with teeth that may be suitable for use in forming a channeled electrode according to various embodiments.

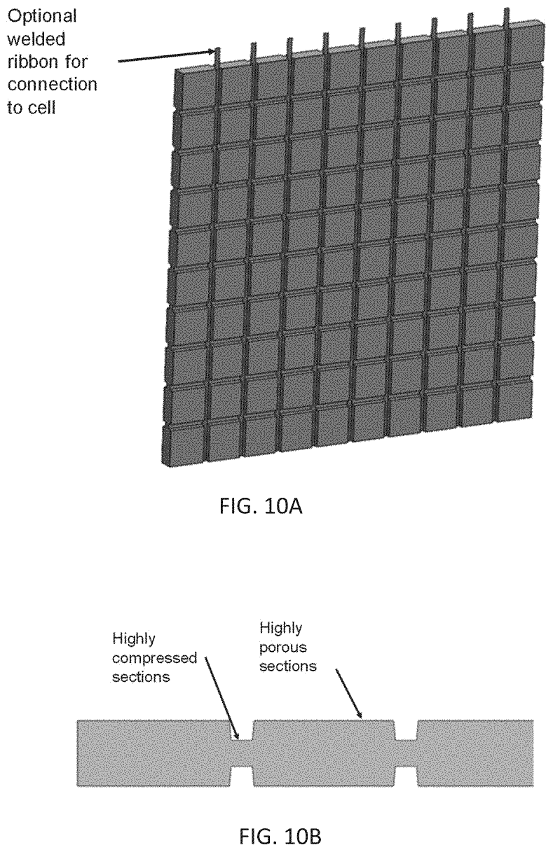

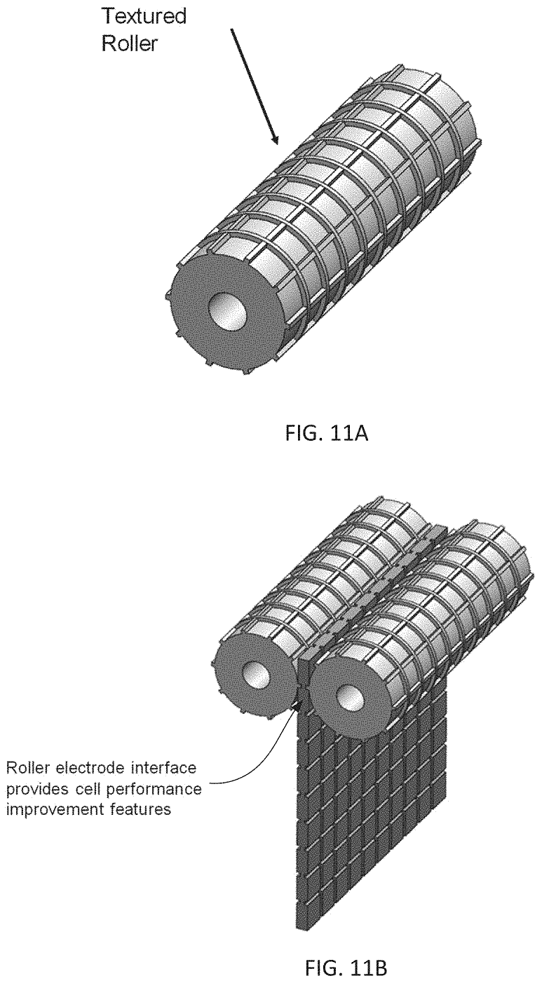

The rollers in a hot rolling press may be textured to intentionally increase the density of the hot compressed material in specific locations. The increased material density could serve two functions: (1) It would add areas of increased strength, improving handleability. (2) It will add highly conductive areas, providing a highway for electron flow. These features would act as integrated/formed bus bars. Steel busbars could then be welded directly to these areas to carry current out of the electrode. FIG. 10A illustrates views of an example channeled electrode according to various embodiments. FIG. 10B illustrates a cross-section of a portion of the example channeled electrode of FIG. 10A. FIG. 11A illustrates an example of a textured roller and FIG. 11B illustrates an example of operations to form a channeled electrode according to various embodiments using two of the textured rollers in FIG. 11A. The rollers in a hot rolling press may be textured to intentionally increase the density of the hot compressed material in specific locations. The increased material density may serve two functions: namely, to add areas of increased strength, improving handleability; and to add highly conductive areas, providing a highway for electron flow. These features may act as integrated/formed bus bars. For example, steel busbars may then be welded directly to these areas to carry current out of the electrode.

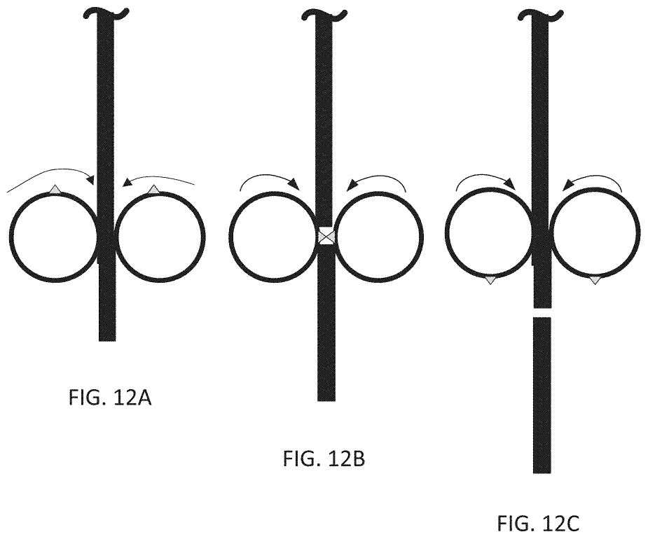

In roll compaction processes, the electrodes may be separated into sheets via a cutting or separating feature integrated into the rollers, which periodically cuts the sheets or provides features in the continuous sheet for subsequent separation. The rollers may be compaction rollers and the applied pressure may be generated at least in part by the compaction rollers. FIGS. 12A-12C illustrate profile views of one example of a cutting or separating feature being used to separate sheets of formed electrodes. In FIGS. 12A-12C the formed electrode sheet is being fed between the rollers (in a downward direction of the orientation shown therein). FIG. 12A shows the formed electrode sheet being initially fed between the rollers. FIG. 12B shows a cutting feature from each roller meeting as the two rollers rotate counter to one another in order to cut the formed electrode. FIG. 12C shows the formed electrode sheet still being fed between the rollers, but with a section below the rollers now cut.

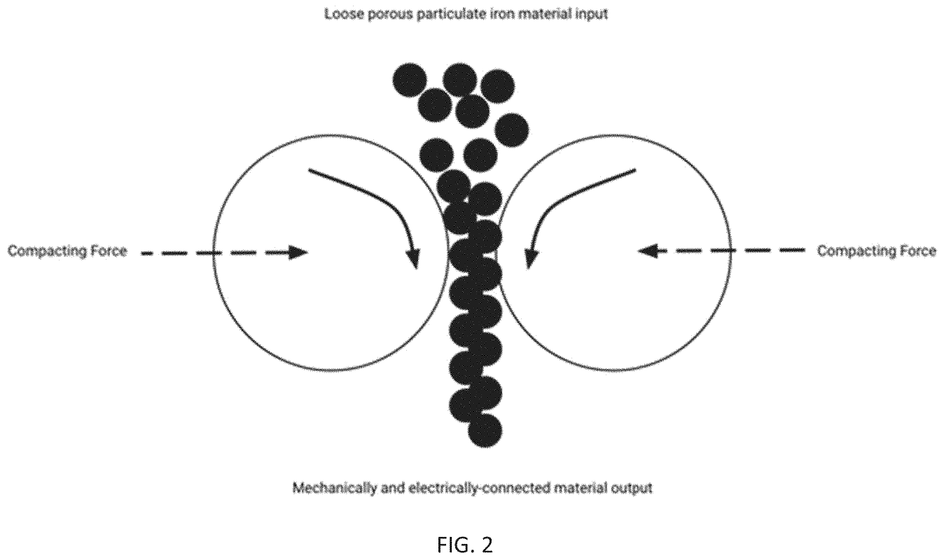

In some embodiments, hot roll compaction or hot briquetting with rollers may be used to bond the porous particulate iron material into a sheet of electrically-conductive material. For example, FIG. 2 illustrates a hot roll compaction embodiment in which mechanically and electrically connected material is output. In accordance with various embodiments, an electrode may be provided into an electrochemical system without applying an external current collector or packing to the electrode The sheet may be patterned or cut during the rolling process to either direction produce the desired geometry for incorporation into a battery electrode, or to aid in the subsequent forming of this geometry. Hot roll compaction techniques like hot briquetting are used to produce highly densified briquettes from porous particulate iron, specifically DRI. The process of hot briquetting of DRI is called the Hot Briquetted Iron (HBI) process. In the HBI process, the goal is to densify (i.e., increase the density of) the DRI as much as possible in order to reduce the amount of microporosity and therefore reduce the reactivity of the material for safer shipping and handling. One may usefully flip the densification paradigm for HBI on its head in order to create a useful battery material: the goal of such a briquetting process would be to densify the material as little as possible while still obtaining strong, conductive metallurgical bonds between the materials. Such a modification of the hot briquetted iron process has several key advantages. First, for in-line briquetting units at DRI plants, the material is already hot and in a reducing/protective atmosphere. This essentially eliminates the costs associated with these aspects of the thermomechanical processing. Second, the process is continuous and high-throughput (some HBI plants produce >1 million tons of HBI per year). Third, the briquetting process is inexpensive—it only adds minimally to the cost of steelmaking inputs. Last, hot briquetting machines already integrate a cutting mechanism into the process to convert a continuous sheet of briquetted material into a discrete set of electrodes. In order to avoid collapse of the microporosity, the briquetting process may generally take place at different operating conditions than are normally applied for the production of the higher-density HBI product. The parameters will be specific to the electrode geometry being produced, and material being compacted, but may be found empirically. First, the DRI temperature during pressing may be reduced to limit the softening of the iron and maintain internal porosity. Second, the pressure applied to the roll(s) may be reduced and allowed to fluctuate up to a certain limit. Third, the rolling speed may be reduced to increase the time during which the iron is under pressure and increase its ability to form interparticle bonds. Fourth, the gap between the rolls may be controlled to higher tolerance to provide a uniform thickness on the compacted electrode.

Material Handling and Modification Before Consolidation of Iron Electrodes.

Material handling for creation of metallurgically bonded iron electrodes presents several challenges. First, the materials should be blended and remain blended throughout feeding. Second, the weight and volume of materials should be controlled to minimize inhomogeneity within and between electrodes. Third, the materials must be properly processed and prepared for bonding via any applicable heating and chemical reactions that are desired to occur. Fourth, any other applicable materials needed for inclusion of the electrode shall be fed into the appropriate apparatus for bonding of the particulate materials.

Surface preparation: The surface of the materials may be optionally prepared through the surface preparation methods described below. The surface preparation may take place at many points during material processing and handling. In order to achieve the desired bonding between particulate of iron, it may be necessary to clean the surface of any impurities or detrimental phases that would interfere, delay or prevent the metallic bond. Of particular interest is the oxide coating often associated with DRI manufacturing; this inorganic compound is designed to prevent sticking during the production of DRI and, as such, will interfere with bonding in subsequent operations. Commonly used techniques such as washing with solvents, acid etching, sand/shot blasting may be used prior to heating and consolidation.

Heating: In many consolidation and/or metallurgical bonding processes, it may be desirable or necessary to heat the material prior to the bonding or consolidation step itself. For example, in order to achieve metallurgical bonding via hot compaction processes, temperatures of >400° C. are often needed. Similarly, in many welding processes (e.g., resistance welding), preheating of material enhances the consistency and quality of bonds. The iron materials may be heated via a large number of methods. In some cases, the porous iron materials may be heated by radiative and/or electric heaters, by inductively coupling to the porous iron material itself, or may be heated by being in the presence of a combusted gas atmosphere. The porous iron material may also self-heat by introduction of oxygen into the process atmosphere and reaction with the porous iron materials. Mechanical action, such as crushing, tumbling, stirring, or ultrasonic agitation, may also be used as a means of heating, whether or not this action is also used to achieve other objectives. The material may additionally or instead be pre-heated and stored in bulk, thermally-insulated storage containers to remain moisture free and eliminate the need to heat very quickly. Heating may occur in continuous furnace such as a rotary hearth furnace, a rotary kiln, a linear hearth furnace, a tunnel furnace, or straight grate furnace, among others. In some cases, the heating atmosphere may also be engineered to accomplish a chemical change in the porous iron materials.

Particle size control and blending: The porous particulate iron materials may be reduced in size, classified according to size, and blended in order to attain optimal particle properties for formation of metallurgically bonded electrodes. Particle size reduction may take place via any one of the techniques known in the art for reduction of particle sizes of particulate materials, including but not limited to high pressure grinding rolls, jaw crushing, gyratory crushing, and/or hammer milling. In some cases, porous particulate iron materials may be combined from two distinct sources or manufacturing processes to produce an optimal blend or size distribution. In other cases, a single input material may be split into various portions, and the various portions may undergo different size reduction and classification processes to arrive at a desired size distribution. The proper size distribution may be assured by use of sieves, air classifiers, or other particle sizing and sorting techniques known in the art for handling of particulate metal materials. Such sizing operations may operate continuously in-line with the material processing, or in discrete batches. Blending or homogenization may be performed to assure product quality and homogeneity. Blending make take place via various blending and splitting techniques appropriate for the particle sizes used. For example, a finer particulate material may be blended in a double cone or vee blender, while a coaster particulate material may be better blended via a series of riffling and combining steps.

Metering, conveyance, and dosing: The porous particulate iron materials may be conveyed, metered, and dosed via appropriate techniques for the particle sizes and mass throughputs of interest. In some embodiments, screw conveyors or other volumetric techniques may be used to provide an even volumetric flow rate of material. In some embodiments, a gravimetric feeder such as a vibratory gravimetric or loss-in-weight feeder may be used to provide a constant input weight per unit time. In some instances, volumetric and gravimetric conveyance may be combined at various points in the material feeding processes. In cases where controlled flow rates are not as important, pneumatic, magnetic, or slurry-based conveyance may be utilized to convey materials between various processing units. Blending may occur at the beginning of conveyance, at the end of conveyance, or periodically throughout material transport to assure material homogeneity.

Material processing and upgrading during conveyance: In some instances, dusts associated with the materials may impede bonding during subsequent processing. In these cases, the porous particulate iron materials may be de-dusted. In some embodiments, the de-dusting may occur via jet-blasting of air onto the particles. In some embodiments, the de-dusting may occur via feeding material through a chamber with sufficient air velocities to enable transport and removal of any dusts generated, such as a vibratory surface which may mechanically remove dust from the surface via agitation and remove it from the porous particular iron material.

Customizing material for use in consolidation processes in terms of shape and material properties: In some instances, the materials used for metallurgical bonding into iron electrodes may have different shapes than the spherical shapes often used in direct reduction processes. In such instances, more suitable shapes may be generated by extrusion, modification of pelletizing techniques, pressing, or other suitable processes. Cylinders, hexagons, octagons, or other shaped may be used to manufacture porous particulate materials.

The Use of Particle Size Reduction Techniques for Fabricating Iron Electrodes.

Metallurgically bonding of DRI can be difficult as coatings are often placed upon the pellets to prevent them from sticking during the various heating, handling, and reduction processes that are performed to manufacture the DRI. This bonding process can still be accomplished via, e.g., the application of increased heat, temperature, pressure or other appropriate process variables—essentially melting, deforming, otherwise densifying and modifying the microstructure to greater extents eventually results in satisfactory bonding. However, the modification of the microstructure due to welding usually results in reducing electrochemical performance due to e.g., densification and attendant losses in microporosity and specific surface area that are needed for electrode performance.

The inventors have found that some particle size reduction processes result in retention of the vast majority of the microporosity with the porous particulate iron material. In reducing the particle size of the material, fresh surface area is exposed that is not covered by the anti-stick coatings used to prevent material adhesion during prior process steps. This fresh surface area can then be metallurgically bonded with comparative ease. The reduction in particle size does not need to be enormous to have a very large effect on the enhancement of adhesion. As a very rough approximation, assuming spherical particles, halving the particle size results in 75% of the surface being un-coated surface area. Reducing the particle size to one quarter of the particle size results in approximately 93.75% of the surface area being un-coated surface area. Thus, small reductions in particle size may result in large changes in material behavior during metallurgical bonding.

The use of such particle size reduction techniques not only usefully enhances the adhesion of the electrodes and quality of the electrical connections, but also ensures that the electrodes are less sensitive to upstream process variations from suppliers and opens up the possible set of suppliers that can supply material for the electrodes because the specifications and restrictions on the types and amounts of coatings are loosened. The use of reduced particle sizes therefore usefully enhances the robustness of the process, reduces electrode variability, and enhances supplier flexibility for material production.

Particle size reduction techniques include jaw crushing, hammer milling, gyratory milling, and pulverizing with a parallel plate pulverizer.

Metallurgical bonding techniques may comprise welding, sintering, or pressing, or combinations of these with other techniques and among the techniques listed. Welding may include DC resistance welding, and AC high frequency resistance welding. Sintering may include sintering under small amounts of pressure, and pressing prior to sintering. Pressing may include hot or cold pressing. Pressing may involve application of pressure along one or more axes.

The Use of Wide or Engineered Size Distributions for Fabricating Iron Electrodes.

Several considerations motivate the use of engineered size distributions in iron electrodes made from porous particulate materials. First, battery electrodes require active material to remain in electrical connection with current collectors so that current can pass through the external circuit. Electrical isolation of active material is a primary form of capacity loss in many battery systems. This is particularly important in metal electrode systems wherein the active material often serves as its own current collector through the thickness of the electrode. As such, systems or methods which ensure a greater degree of contact or a greater robustness of electrical contact between active materials in metal electrodes are useful for enhancing the robustness of the battery electrode with respect to mishandling and/or active material degradation. Second, compression and/or compaction of porous metallic materials is a method for producing electrically connected, high porosity materials for battery electrodes. However, such compaction processes are inherently limited in that porosity is desirable in a battery electrode, and the compaction processes often cause densification or mechanical degradation via plastic deformation and rearrangement of the particles being compacted. At the same time, the battery electrode should be mechanically robust such that it can be handled, placed into assemblies, and maintain excellent performance and connectivity throughout life. Mechanical robustness increases with increasing degree of compaction, while battery performance often decreases with increasing degree of compaction—these two desirable features of a battery are thus often in direct tension in compaction-based electrode production processes. Methods and/or systems for escaping this engineering tradeoff would thus be highly useful for the production of compressed metal electrodes.

Wide and/or engineered particle size distributions, including multimodal packings, are often capable of producing more contacts per unit volume within a particle packing and increasing the packing density of the materials contained within the packing relative to narrower particle size distributions. Thus, wide and engineered particle size distributions are useful to engineer the robustness of particle contact in compressed electrodes wherein the active material is also the conducting phase while simultaneously increasing the packing density. A higher packing density leads to lower thicknesses and lower total system costs (due to, e.g., less electrolyte needed in the cell)

A problem induced by wide and/or engineered particle packings is that the smaller particles can rattle inside the interstitial space of the larger particles. The volume fraction of such rattlers is a strong function of the particle size distribution, shape, and packing method of the materials, with the implication being that wide and engineered packings can result in a lack of repeatability in electrode properties and performance batch-to-batch and run-to-run. However, the space which these particles have to rattle is often quite small, often being on the order of less than 1% of a particle diameter.

There is thus an opportunity for significant enhancements in electrode repeatability and performance by combination of wide and/or engineered particle size distributions and the use of electrode compaction methods that are capable of accomplishing uniaxial plastic deformation of >1%. The imposition of a small amount (˜1%) of densifying, plastic deformation may cause a significant increase in the number and weight fraction of interconnected active materials, and greatly increase the robustness of the connections between the active materials. In the case of iron electrode materials made from materials with high internal porosity (e.g., iron sponge powders), this deformation may be accomplished by either application of very high forces at close to room temperature (˜0.5-50 MPa) or hot compaction of the iron at somewhat lower pressures (˜0.1-10 MPa), but greatly elevated temperature (>400° C. and <1200° C.). There are of course, a continuum of temperature and pressure combinations in between these two extremes. Compaction techniques other than uniaxial compaction are possible.

It has further been discovered that the mechanical robustness of the resultant electrode materials is much greater at the same degree of compaction (e.g., at the same applied pressure and/or at the same densifying uniaxial strain) when a wide and/or engineered particle size distribution is used for the feedstock material to the compaction process.

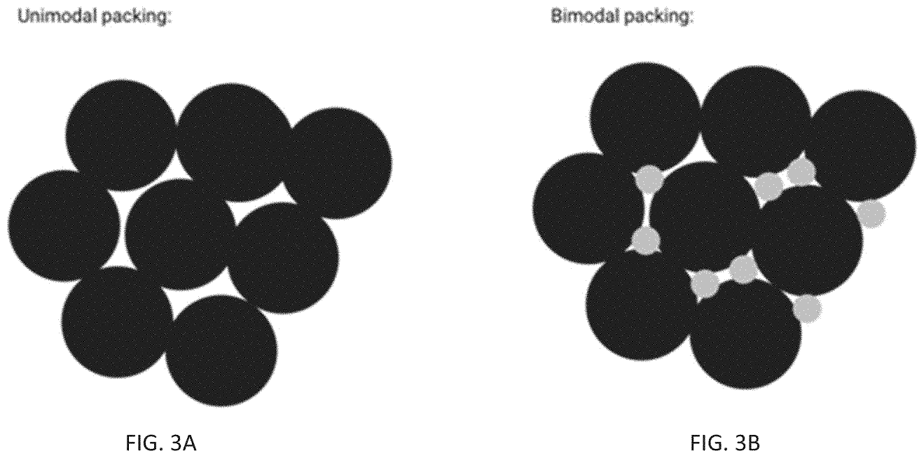

The use of a wide and/or engineered particle size distribution is thus useful for 1) creating a more robust conductive network between particles, 2) Enhancing packing density and reducing electrode thicknesses and systems costs, and 3) enhancing the mechanical robustness of the resulting product. FIGS. 3A and 3B illustrate an example of a comparison of unimodal packing, shown in FIG. 3A, to bimodal packing, shown in FIG. 3B, showing the different particle size distributions in the bimodal packing and the smaller particles filing in gaps between the larger particles.

Size ranges relevant for various forms of DRI and some non-limiting discussion about how to make them are provided below. A key consideration is the preservation of the microporosity of the sponge iron while reducing the particle size. These particle size reduction techniques have been shown work to reduce particle size while substantially preserving the internal microporosity of the sponge iron. As one non-limiting example, DRI may be in the form of whole pellet DRI, such as of pellets from approximately 6 mm to 20 mm formed from a shaft furnace. Other processes may have different preferred size ranges. For example, some DR processes, such as fluidized bed processes, produce inherently smaller DRI particles. As one non-limiting example, fluidized beds may be used resulting in particles exclusively having a size less than 6 mm. As one non-limiting example, DRI may be in the form of crushed DRI which may usually be at least two times smaller than whole pellet DRI, such as from approximately 3 mm to approximately 10 mm, often 3-5 times smaller, such as 1 mm to 6 mm. As non-limiting examples, such DRI may be formed in manners including by a jaw crusher, gyratory crusher, high pressure grinding rolls, and/or a lower energy hammer mill. In some cases, the particle size of the DRI may be reduced through non-contact or limited contact methods such as spinning the DRI so fast that it disintegrates. As one non-limiting example, DRI may be in the form of finely crushed or pulverized DRI, such as that having a size from approximately 0.1 mm to approximately 2 mm. As one non-limiting example, such DRI may be made with a higher energy hammer miller, vertical grinding mill, and/or other finer grinding process. As other non-limiting examples, other forms of sponge irons may also be used, such as sponge irons produced for the powder metallurgy industry via, e.g., the Hoganas sponge iron process. Some specific details of embodiments of engineered size distributions may include whole pellet DRI mixed with crushed DRI and/or mixed with DRI fines, where the crushed DRI is 3 to 7 times finer than the whole pellet DRI. Some specific details of embodiments of engineered size distributions may include whole pellet DRI mixed with crushed DRI and/or mixed with DRI fines, where the DRI fines are waste products from a DR plant unable to go into an electric arc furnace. Some specific details of embodiments of engineered size distributions may include whole pellet DRI from a shaft furnace mixed with fluidized bed DRI of much finer size. Some specific details of embodiments of engineered size distributions may include crushed DRI incorporating DRI crushed with different processes and therefore achieving different particle size distributions. Some specific details of embodiments of engineered size distributions may include a crushing process where the crushing process is engineered to have an inherently wide size distribution.

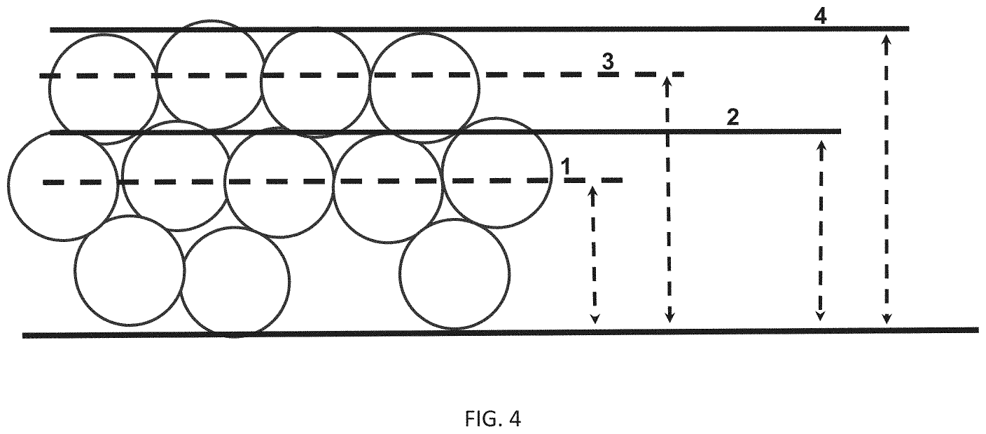

In some embodiments, a target electrode thickness may be desirable. In such circumstances, the particle size may be selected such that it is either much less than the total electrode thickness, or such that the particles form an integer number of layers across the thickness of the electrode. This is shown in FIG. 4, an illustration of desirable (solid horizontal lines) and undesirable (dashed horizontal lines) thicknesses for the anode relative to integer increments of layers of porous particulate iron (e.g., DRI) particles. It may be beneficial to coordinate between Anode Thickness and Porous Particulate Iron Particle Diameter to ensure consistent packing within the anode. Also, adding some fraction of crushed porous particulate iron may help mediate this effect by reducing the incremental nature of desirable thicknesses regardless of whole pellet diameter. FIG. 4 illustrates example desirable (horizontal lines 2 and 4) and undesirable (dashed lines 1 and 3) thicknesses for the anode relative to integer increments of layers of DRI particles. It may be beneficial to coordinate between Anode Thickness and DRI Particle Diameter to ensure consistent packing within the anode. Also, adding some fraction of crushed DRI may help mediate this effect by reducing the incremental nature of desirable thicknesses regardless of whole pellet diameter.

In certain embodiments, the iron electrode materials, and iron electrodes disclosed in the present invention may be used as the negative electrode in alkaline electrochemical cells such as Fe—Ni, Fe—MnO₂, or Fe-air batteries; other positive electrodes known to those skilled in art may be paired with the iron (negative) electrodes.

Re-Heating and Controlled Cooling of DRI to Achieve a Phase Separation.

DRI and other porous particulate iron materials represent inexpensive forms of iron for use in iron negative electrodes in batteries, but DRI and other porous particulate iron materials often contain a significant amount of iron carbide, often called cementite. Cementite and iron have complex electrochemical behavior when galvanically coupled such that the engineering of an iron negative electrode composed of starting materials of both iron and cementite has been found to be difficult, but electrodes having a similar quantity of graphite may be easier to engineer due to the simpler reaction pathways. Such low-cementite electrodes may be higher performing in practice.

The inventors have discovered that the metastable nature of iron carbide may be used to engineer higher performing iron electrodes that contain carbon. More specifically, one can heat a cementite-containing porous particulate iron materials to a temperature such that the iron carbide decomposes to form iron and graphite, thereby improving the performance of the porous particulate iron materials. The general requirements for the heating are that the material is held at a high enough temperature that the metastable iron carbide phase converts to iron and graphite. The kinetics of this decomposition reaction are complex, but well-studied in the art of steelmaking. The temperature and time can be manipulated to manipulate the microstructure lengthscale of the iron and graphite phases. In general, the lengthscale of the phase separation may be a function of the application of the battery electrode, with lower temperatures promoting finer phase separation and higher temperatures promoting coarser microstructures. In general, the temperature for the treatment should be between around 300° C. and below around the iron-carbon eutectoid temperature of 727° C. Above this temperature, a significant amount of carbon is soluble in the iron, thereby placing a bound on the amount of cementite that can phase separate. Preferred temperature ranges may be between 500 and 650° C., depending on the materials used.

One can also keep porous particulate iron materials hot after discharge from a reduction furnace in order to permit the cementite in the porous particulate iron materials to phase separate without having to re-heat it, or to reduce the amount of time and energy needed to re-heat the materials to the phase separation temperatures. This process may be termed a ‘hot discharge.’ The hot discharging and re-heating concepts can be combined: the porous particulate iron materials can be cooled to an intermediate temperature and re-heated and held at the re-heating temperature to achieve a phase separation. The cooling profiles of the processes may be controlled to control the microstructural characteristics of any remaining cementite.

Methods of Purifying Carbon from Iron Electrodes.

Most broadly, it is often of interest to reduce the impurity levels in electrodes for secondary batteries in order to improve performance of the electrode, but this generally comes with attendant costs due to e.g., additional processing. Innovations that are low-cost ways of purifying electrodes are of interest for many different types of electrodes. In some embodiments, it may be advantageous to have low levels of carbon in the iron negative electrodes for secondary storage applications. This may be, for example, for electrochemical or cell performance reasons, or for manufacturability reasons like the ability to consolidate and bond DRI into an anode through hot compaction. Because the final carbon content in DRI may vary as a function of input materials, it would be desirable to be able to reduce the levels of carbon in DRI through manipulation of processing parameters and/or the use of additional processes.

Chemical reactions of porous particulate iron materials with gaseous atmospheres can be used to alter the carbon content of the iron materials. Several of these are described below. These reactions may take place through selective modification of the processing atmospheres in reduction processes, sintering processes, or as a separate, dedicated chemical treatment process.

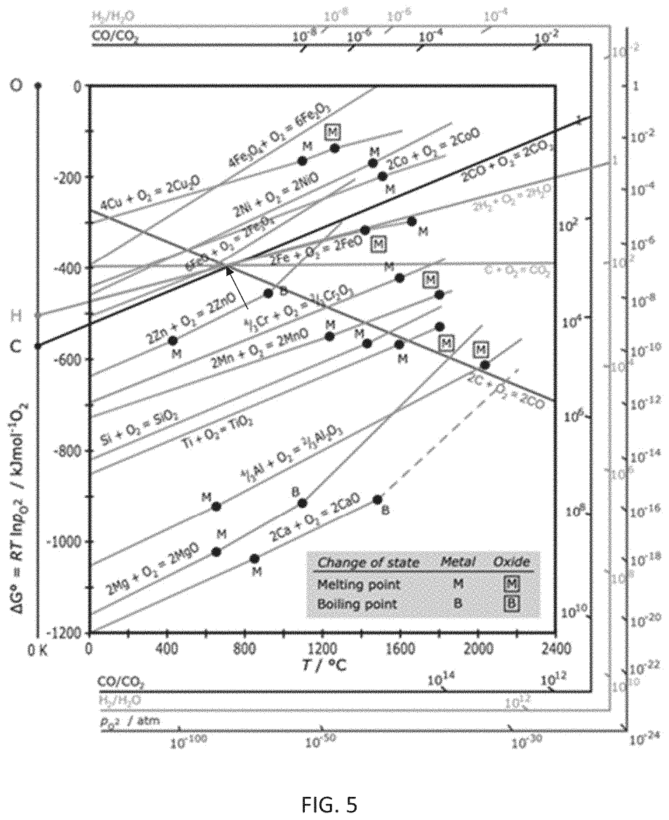

The use of trace oxygen to reduce the carbon content of porous particulate iron material: One potential method for reducing the levels of carbon in porous particulate iron material is to deliberately expose it to an oxygen-containing atmosphere while the sponge iron is at elevated temperatures, for example by allowing traces of oxygen into the atmosphere surrounding the DRI. The objective would be to oxidize the carbon in the sponge iron such that it is removed from the sponge iron material. The reaction that takes place would be either C+O2->CO2 or 2C+O2->CO. Per the Ellingham Diagram shown in FIG. 5, the temperature at which these reactions start to be spontaneous is ˜700° C. (depending on atmosphere purity). The free energy of oxidation of carbon and iron cross around this temperature: ˜700° C., indicating that carbon can reduce iron as long as the carbon-containing gaseous byproducts are swept away as the reduction reaction proceeds. The reaction is of the form: Fe₃O₄+4C→3Fe+4CO (or, depending on the temperature, Fe₃O₄+2C→3Fe+2CO₂, with similar other reduction reactions existing for the other iron oxides). This reaction creates a gaseous byproduct, either CO₂ or CO, which needs to be swept away in order for the reduction reaction to continue.

Use the oxygen in the DRI to remove the carbon in the porous particulate iron: If the temperature is properly selected, carbon can reduce iron oxides even when both are in the solid state. Generally, this can take place above ˜700° C., when the oxidation of carbon starts to become thermodynamically favorable relative to the oxidation of iron, resulting in reactions of the form FeO+C [symbol] Fe+COg or 2FeO+C [symbol] Fe+CO2,g. This can result in removal of carbon impurities from the porous particulate iron and the creation of more metallic iron in place of iron oxides, both of which are desirable from the perspective of electrochemical behavior. A flow of inert gas such as argon or nitrogen is needed to drive the reduction reaction to the right. The amount of flow can be chosen based on the amount of gaseous products that need to be removed as the reduction process proceeds. Using the oxygen that is already present in the porous particulate iron is convenient in that the reaction does not require tight control over total oxygen content of the atmosphere and is self-limiting and therefore easily controlled. Undesirable oxidation of iron is intrinsically avoided, as no oxygen is introduced.

Preferred temperature ranges for this method of removal of the carbon from the iron may be chosen such that the solubility of carbon in iron is high, and thus that dissolution kinetics of Fe₃C and graphite are rapid (i.e., above the Fe—C eutectoid of ˜723° C.). The upper end of the temperature range is limited by heating costs, densification, and sticking of porous particulate irons during material feeding that can occur at elevated temperatures. Thus, temperatures are desired that are not so high as to enable these phenomena. Generally, optimal operating temperatures are between ˜700° C. and ˜900° C. for the decarburization of iron by its own oxides.

In some embodiments, a sponge iron may be used directly from a DRI production plant, taking advantage of the latent heat trapped in the material. In such cases extra inert gases feeds and heating may be used to adjust the temperature and atmosphere of the material to enable decarburization.

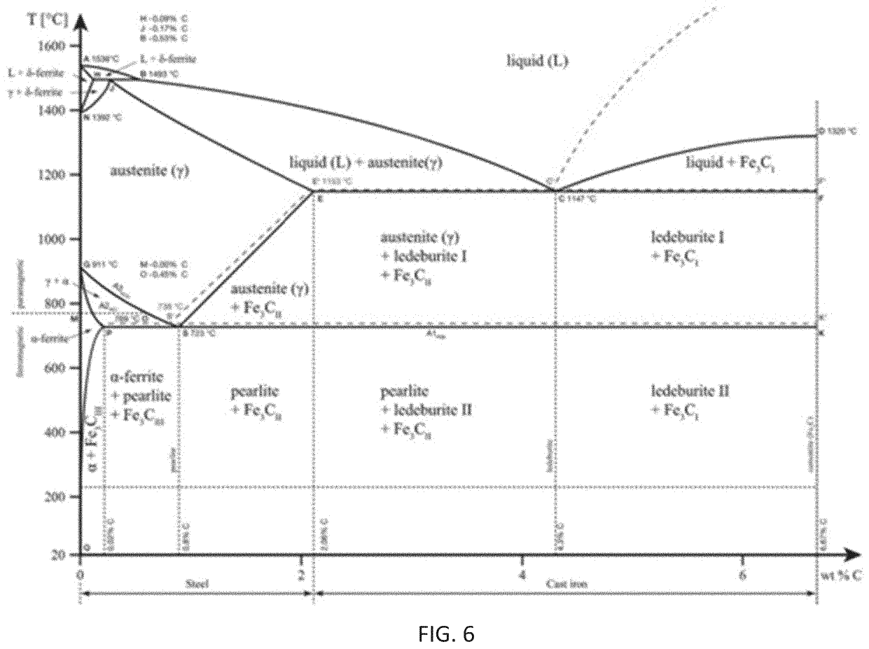

The iron-carbon phase diagram is shown in FIG. 6. The rate limiting step for FeO—C reduction reactions below the Fe—C eutectoid at ˜723° C. is often the dissolution and diffusion of carbon in iron such that the carbon can reach adjacent oxides and reduce them. In order to enable this reduction to proceed more rapidly, the material must be heated above the eutectoid, above which the solubility of carbon in iron increases by roughly 40 times, thereby enabling much faster diffusion of the carbon to the oxides in the sponge iron, and their attendant reduction.

Use a chemically active gas with less oxidizing power to facilitate decarburization without oxidation of iron: In some circumstances, it may difficult to achieve sufficient decarburization without attendant oxidation of the sponge iron. In such circumstances, a third method for achieving decarburization can be to add a chemically active gas to the atmosphere holding the sponge iron in order to remove the carbon. In some cases, this is preferred as it is less prone to oxidizing the iron than pure iron is. In some embodiments, one can use hydrogen to remove carbon via reactions of the form: Cs+2H2,g->CH4,g (this works on both cementite and graphitic carbons). The kinetics and thermodynamics of this reaction work best at intermediate temperatures between 300 and 800° C., with the decarburization reaction becoming stoichiometrically limited at high temperatures (>800° C.) and kinetically slow at low temperatures (<300° C.). In some embodiments, one can use carbon dioxide to decarburize sponge irons at high temperatures (typically above 700° C.). The temperatures and partial pressures at which CO produces carburization are well-studied in iron-making and are governed by the Boudouard reaction: CO2,g+Cs<-->2COg. Adding CO2 will drive this reaction to the right to form CO via the oxidation of carbon. The lower oxidizing activity of CO2 compared to oxygen may usefully limit the amount of iron oxidation that takes place. In some embodiments, one can use water as a decarburizing gas, resulting in reactions of the form Cs+H2Og->COg+H2,g. Water can be a more effective decarburizing agent than hydrogen kinetically, and its reaction with carbon results in the formation of reducing gases that can limit or prevent iron oxidation, and in some cases may result in reduction of iron oxides. Water may be added as an effective decarburizing agent at similar temperature ranges to those used for hydrogen. The concentration of the water may be controlled by bubbling inlet gases through a water column at a controlled temperature, thereby controlling the dew point.

The inventors have found that some forms of carbon found in DRI's exhibit faster decarburization kinetics than other forms of carbon. In some cases, DRI with high graphitic carbon content may decarburize faster than DRI with comparable total carbon, but with a high cementite carbon content. As such, a DRI with a high graphitic carbon content may be usefully used as an input to decarburizing processes in order to minimize the amount of gases, time, and temperature needed for processing. decarburization reactions that can more easily be driven to completion (or where the reaction can be well approximated as being driven to completion) exhibit more stable product characteristics and uniformity. Uniformity of material properties across and within a powder particle is a highly advantageous property for battery active materials, as uniform starting compositions prevent concentration of currents and accelerated degradation at certain points in the electrodes. In some embodiments, the decarburized materials are included in a metallurgically-bonded electrode. In some embodiments, the decarburized materials are included in electrodes that are not metallurgically bonded, but may, for example be included in designs comprising active materials compressed between two current collectors.

In some embodiments, combinations of process gases may be used to control the chemical reactions. For example, H2/H2O and CO/CO2 mixtures may be used for controlled decarburization of the porous particulate iron materials. Such mixtures may, for example, usefully set the oxygen potential of the process atmosphere so that the oxygen can oxidize the carbon present in the iron without oxidizing the iron itself. The compositions of such process gases may be computed from thermodynamic data or determined empirically.

Decarburization may be performed in various material processing equipment, including kilns, tunnel furnaces, pusher furnaces or rotary hearth furnaces.

Post-Processing of Metallurgically Bonded Electrodes:

Following bonding and decarburization, the formed electrode may undergo a series of treatments including (1) rapid cooling, (2) cutting, (3) surface cleaning, and (4) application of a protective layer.

Various techniques can be applied for the rapid cooling of the compacted electrode. Rapid cooling is preferred to minimize the risks of re-oxidation and phase transformation that can occur during slow cooling. In some embodiments, cooling can be accomplished by blasting air or inert gases, where the flow of gaseous species is in sufficient volume and velocity to enhance heat transfer from the compacted electrode to the gas; as appropriate, the gas can be recycled via heat exchangers or other means to extract and reuse the heat extracted from the compacted anode. Other embodiments may include the use of liquid cooling, such as spraying or immersion in a tank; continuous operation necessitates the use of conveyance in and out of the liquid cooling area by means such as gravity incline, conveyor belt, or other commonly used methods. Liquids shall be selected as to enhance cooling and prevent oxidation of the electrode either by chemical incompatibility or by exceeding the oxidation reaction kinetic; liquid such as water, oil, nitrogen or the battery electrolyte can be used alone or in combination. In some embodiments, the cooling liquid may also serve as a protective coating.

After cooling the dimensions of the electrode may require adjustment to meet the tolerance of the battery.

Surface cleaning of the formed electrode may be necessary to remove residues of compaction and subsequent steps. Commonly used techniques such as washing with solvents, acid etching, sand/shot blasting may be used prior to heating and consolidation.

The final step in the processing of the anode is to coat the electrode with a protection layer to prevent reoxidation of the electrode during transport, storage, handling and battery assembly. In some embodiments, the coating may consist in the formation of a thin iron oxide layer in a controlled, slightly oxidizing atmosphere (also known as passivation). Other embodiments may include the spraying or dipping of the compacted anode into a rust-preventive chemical, or liquids compatible with the electrolyte of the battery. Other embodiments may include the application of a sealed film or casing under vacuum.

Handling and Automation for Handling

The mechanical nature of the consolidated porous particulate iron Electrode lends itself to be of limited strength and increasing mass and bulk depending on the carbon content and consolidation process. This limited strength means that the handling of these materials can be difficult and require novel handling features, processes, and mechanisms for battery electrodes. Means can be used to increase the strength and handleability of the electrode including a material backing joined to one or both sides of the electrode. The backing may be a permeable iron bearing material which acts secondarily as a current conducting substrate. The backing material may also be in the middle of the electrode, with porous particulate iron material consolidated on both faces. There may be areas in the consolidated electrode specifically manufactured with a high density, providing for increased strength and conductivity, engineered in a pattern to ease electrical current flow or provide for increased strength in load bearing locations. There may be a protective frame applied to a single or multiple edges of the electrode which may serve to increase handling strength, in addition to providing a location for an electrical connection. There may be features in the electrode itself or these protective frames which allow for the electrode to be fastened, located, constrained or hung within an electrochemical assembly. These features can be manifested by holes, groves, tracks, shelves and may allow for the electrode to only contact its mechanical support and current conduction path by the protective frame and not the DRI derived material itself. The design of the electrode may include specific features which alloy the electrodes to be densely and securely packed in a shipping vessel, which would then be returned to the place of manufacture to be re-used. The electrode consolidation may be performed at the location of the material reduction, or decarburization, and the electrode may be cooled and passivated by immersion into the electrolyte itself, within a vessel which serves as liquid containment for the electrochemical device.

Methods for Separating Units of Metallurgically Bonded Iron Electrodes

Processing thick or brittle electrodes presents several challenges, as such electrodes cannot curl or otherwise package compactly through jelly roll or other similar techniques, such as those used for lithium ion batteries. As such, thick or brittle electrodes must be cut or made into a desired size and shape. Such a process should yield electrodes of consistent shape and weight. Difficulties arise in continuous processing, where a brittle material must be cut to shape without damaging the rest of the electrode. Such cutting processes are made even more difficult when brittle electrodes are made out of metal and especially metallurgically bonded metal particles, such as iron. Such metallurgically bonded electrodes tend to be made of hard and temperature-resistance materials microscopically, but may be brittle macroscopically due to e.g., the size of the contact points between particles being substantially smaller than the particles themselves and attendant stress concentration at the contact points. The microstructure of metallurgically bonded metal electrodes tends to be highly engineered to attain the right combination of porosity, surface area, and mechanical robustness for a given application. Methods of cutting that preserve this engineered microstructure in as much of the electrode as possible are desired to minimize lost or under-utilized material.

System architecture: In some cases, the metallurgically bonded electrodes may be fabricated in such a way that they are formed in their desired shape and size during the bonding operation, and as such, no further separation is required. In some cases, fabrication of individual electrodes may take place via any number of integrated cutting, stress concentrating, or other operations during the bonding operation itself, such as the stress-concentrating features included in rollers used for the Hot Briquetting of Direct Reduced Iron. In some cases, the electrode may be formed continuously, and separated at a later stage of the process. In the cases where the electrode is formed continuously, the electrode may be made into a desired size by a cutting or otherwise separating operation located along the path of the electrode. The separating operation may be stationary, or it may move in-line with the electrode using infrastructure such as a cam system.

Separating mechanism: In some cases, the metallurgically bonded iron electrodes may be cut or otherwise separated in any way it is common to cut metals and other materials, especially those that are brittle, including, but not limited to: with a shear or other pressing action, with an abrasive saw, with a diamond saw, with a chainsaw or other rotary cutting tool, with a waterjet, with a bead blaster stream, with torches, with a laser, or via scoring and snapping. In some cases, a combination of these cutting or separation methods may be employed, such as a rotary cutter being used to score an electrode followed by a snapping mechanism. In some cases, the electrodes may be separated by use of a high-velocity fluid, such as an air or oxygen knife, engineered for achieving certain mechanical and/or thermal conditions on the electrode. In some cases, the electrode may be engineered with a thermal profile that is favorable for cutting or separating, via methods including, but not limited to, oxygen introduction to the electrode. In some cases, oxygen may be introduced to the cutting process to cause a local heating reaction where the oxygen reactions with the metal of the electrode to cause it to heat. In some cases, the oxygen introduction or other heat source may be used to create a thermal gradient and local softening of the electrode at a point that usefully causes separation by e.g., cracking, melting, or combinations thereof.

Strengthening: In some cases, the cutting mechanism may strengthen the electrode, which may occur through thermal or mechanical means. In some cases, a strengthening step may be included before, during, or after cutting.

System Architectures for Hot Compressed Anode Manufacturing Equipment.

Hot compressed electrodes can be made at a very low cost, and made with high throughput equipment. This is especially true if this equipment is integrated into a DRI making facility. The DRI could be transferred directly from a DRI furnace to hot compression equipment. This interface could look very similar to the DRI furnace—HBI interface, where hot material directly flows from the furnace in the hot briquetting equipment. This arrangement would eliminate the need to reheat DRI before entering the hot compressing equipment. This would save cost, energy, and ultimately increase the throughput of the manufacturing equipment.

Hot compressed anodes can be made at a very low cost, and made with high throughput equipment. A hot compressed anode manufacturing line could be collocated with a DRI making facility in order to reduce shipping and handling costs during manufacturing. This hot compressed anode equipment however, does not need to be integrated with the DRI making equipment. It may be advantageous to decouple these two equipment sets to allow for pre processing of the DRI before running the material into the hot compressing set up to improve material properties relating to porosity, shape, and adhesion.

Hot compressed anode manufacturing equipment could be designed such that is it containerized, meaning it is modular and mobile. This could be very advantageous as the cost of the equipment may be very expensive, and would likely be used for a specific project, which will likely receive DRI from the nearest DRI plan to reduce shipping and handling costs. Containerized hot compressed anode making equipment could be described as, but not limited to, the following; Heating, pressing or rolling systems, fixtured within a standard 40 ft container(s), Manufacturing equipment within 45 ft container(s), This container may be equipped with standard interfaces for integrating into a DRI furnace, DRI handling equipment, hot compressed anode handling automation. This would allow for road or sea shipping to project or DRI making sites. Equipment could easily be shipped to DRI making sites which are as close as possible to Form energy's energy storage deployments. This containerized equipment could include decarburization functionality

The mechanism used for hot compressed anode manufacturing equipment could be described as, but not limited to, the following design methodologies. It may utilize a continuous roller system similar to that seen in hot briquetting equipment architectures. it may utilize a semi continuous process such as a uniaxial pressing system. This could include automated material handling on the inlet and outlet of this uniaxial press to increase throughput of the equipment. The pressing system could utilize the following actuation systems; A hydraulic or air driven piston. Cam driven actuation. Lead screw driven actuation, Electromagnetic actuation. This mechanism could include guided parallel plates to ensure dimensional uniformity and stability of the compact.

The mechanism used for hot compressed anode manufacturing equipment could be described as, but not limited to, the following design methodologies. The material could be fed into the pressing apparatus using a conveyor belt like drive mechanism. This could be a standalone conveyor or a conveyor belt which is then integrated into the anode electrode and used for current collection.

The mechanism used for hot compressed anode manufacturing equipment could be described as, but not limited to, the following design methodologies. Linear or rotary pressing equipment (similar to pill pressing equipment) which employ multiple hot pressing zones and material handling which accommodates multiple parallel or staged hot pressing zones. This equipment could create electrodes in the form factor or small (10 cm×10 cm) tiles or large (100 cm×100 cm) panels

The anode assembly may include an integrated current collector

The actuation method for pressing the material together could also act as an actuation method to cut the integrated current collector from a continuous sheet

System architectures for hot compressed anode embodiments

The reactor architecture ideally employs large area (˜1 m2) metallurgically bonded anode electrodes manufactured directly from DRI or an upstream material in the steel making process. Large area electrodes are difficult to make via the pressing or roller manufacturing process because they require very large, rigid pressing equipment. It may be advantageous to build large area electrodes from smaller pieces made with smaller, more simple automation equipment. A hot compressed anode may be assembled using smaller hot compressed anode units which are then bonded together. This assembly method includes and is not limited to; welding electromechanically either directly to the DRI compact or to an integrated and/or protruding current collector, forging, thermal bonding, electrochemical sintering.

While utilizing a hot roller approach, anode electrodes could be manufactured into panels or small pieces (30 cm×30 cm) by employing large rollers which have cut out features in the roller to form a compact in sheet form. Material would be formed in the void fraction of the roller cutaway. As the roller turns, and cut away segments in the roller ends, the sheet compact would be “pinched off” and cut into a sheet.

The method listed above could also be used to create an anode assembly where multiple DRI compacts are formed and connected to a single steel mesh current collector. This string assembly could then be handled in a continuous form or cut at a later step for easier handling.

Conversely, in a continuous process, a continuous sheet of material could be created. This material could be continuously pulled for a continuous or semi continuous pressing system and then cut at a further processing step later in the manufacturing process line.

Containing DRI can be difficult and costly, a simple method to circumvent this issue is to create small packets of DRI for handling and containment. These packets could then be compressed directly in a hot pressing apparatus. These packets could be made from either a metal mesh like material or a plastic material. If made from plastic, the packet casing could be burned off thermally at a later step in the anode making process.

Methods for Current Collection from Metallurgically Bonded Electrodes

It is difficult to current collect from some metallurgically bonded iron electrode architectures, and especially iron electrodes which are produced from welding or hot compaction. More specifically, the high currents produced from such electrodes often require welded connections and it can be difficult to weld directly to electrodes made from highly porous iron materials. In some instances, a current collecting material that can be more easily welded to a busbar or terminal can be embedded within or on the faces of the electrode, or at the end of the electrode that must be connected to the external circuit. The current collecting material may be composed of strips of metal, mesh sheets, perforated sheets, non-uniform branched metal textiles, or wires. In some embodiments, the current collecting material may be incorporated into the electrode during the same metallurgical bonding process that bonds the porous particulate iron material to itself, whereas in other embodiments the current collector may be incorporated into or bonded onto the electrode in a second bonding step. The current collecting materials may be composed of any materials suitable in the art for fabricating current collectors for electrodes. In some embodiments, the current collector is made of steel, nickel, and/or copper. In some embodiments, a less expensive current collector material may be coated with a corrosion-resistant material, as in a nickel plated steel.

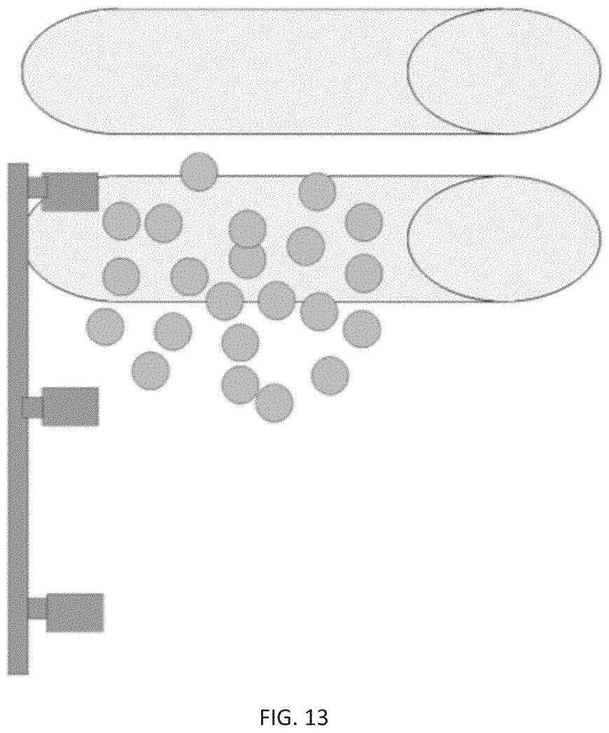

In some embodiments, the current collector materials may span the entire face of the electrode, whereas in other embodiments the current collectors maybe be embedded solely near the portion of the electrode near the terminals to facilitate welding to adjacent external circuit elements. In cases where the current collector is embedded in only a portion of the electrode, the current collector may be embedded in the side of an electrode produced with a rolling process, and the electrode may be connected to the external circuit through this current collector embedded in its side as illustrated, for example, in FIG. 13. A hopper may sit above the rollers and a thin slot may be created to allow for the passage of a “tab-strand.” The tab-strand may be compressed in the nip with the iron, on a desired cadence. Also, a slitter downstream may remove the carrier. If the tab-strand needs to be the length of the slab, then a similar cut-out may be made on the opposite side.

In some embodiments, the metallurgically bonded electrode may feature holes for bolts and ring terminals to attach to for current collection.

In some embodiments, busbars are directly metallurgically bonded to the metallurgically bonded electrodes.

In some embodiments, the current collector may serve as a basket to contain the material during a pressing or welding operation, permitting material containment and also allowing the current collector to become bonded to the active materials.

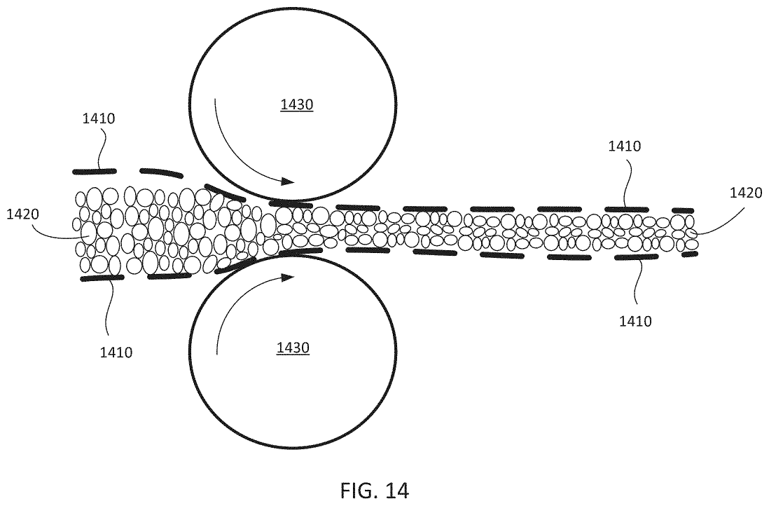

In some embodiments, structural facing layers 1410 may be applied on one or both sides of the anode. This is analogous to the paper facing on panels of drywall, without which a sheet of drywall would very weak and nearly impossible to handle. The facing layers 1410 may be made from a suitable metallic material, such as steel or nickel, in a suitable format, such as wire mesh, expanded metal, or perforated sheet. In some cases, the facing layer 1410 may be formed of plastic or another non-metallic material. The facing layer 1410 may be bonded to the DRI 1420 as part of a bonding process (whether using rollers 1430, uniaxial pressing, or another process) so that it is integrally bonded to the surface of the anode. The facing layer 1410 may be inspired by the potential need for added mechanical robustness, but it may also play a role as a current collector, and it could also serve as a retention screen to ensure that any loose particles of DRI 1420 (whether they failed to bond during hot compaction, or they come loose after cycling) cannot migrate out of the Anode envelope and disrupt the functioning of the cell. The facing layer 1410 could also play a role as a mechanical interface structure, whereby the anode can be mounted to other elements of the cell during assembly. The facing layer 1410 could play a role during anode manufacturing by e.g., acting as a conveyor on which DRI 1420 can be metered out and transported to the compaction step. In some embodiments, a perforated steel mesh may be bonded to the faces of the electrode on both sides, forming a sandwich structure with a current collecting, structural element on the faces that enhances current collection, mechanical integrity, and handleability simultaneously. Structural facings on the electrodes need not be current collecting elements, and can be made of plastic or other suitable materials instead. An example of how a structural facing may be applied to an electrode is shown in FIG. 14.

Various embodiments may provide devices and/or methods for use in bulk energy storage systems, such as long duration energy storage (LODES) systems, short duration energy storage (SDES) systems, etc. As an example, various embodiments may provide batteries for bulk energy storage systems, such as batteries for LODES systems. Renewable power sources are becoming more prevalent and cost effective. However, many renewable power sources face an intermittency problem that is hindering renewable power source adoption. The impact of the intermittent tendencies of renewable power sources may be mitigated by pairing renewable power sources with bulk energy storage systems, such as LODES systems, SDES systems, etc. To support the adoption of combined power generation, transmission, and storage systems (e.g., a power plant having a renewable power generation source paired with a bulk energy storage system and transmission facilities at any of the power plant and/or the bulk energy storage system) devices and methods to support the design and operation of such combined power generation, transmission, and storage systems, such as the various embodiment devices and methods described herein, are needed.

A combined power generation, transmission, and storage system may be a power plant including one or more power generation sources (e.g., one or more renewable power generation sources, one or more non-renewable power generations sources, combinations of renewable and non-renewable power generation sources, etc.), one or more transmission facilities, and one or more bulk energy storage systems. Transmission facilities at any of the power plant and/or the bulk energy storage systems may be co-optimized with the power generation and storage system or may impose constraints on the power generation and storage system design and operation. The combined power generation, transmission, and storage systems may be configured to meet various output goals, under various design and operating constraints.

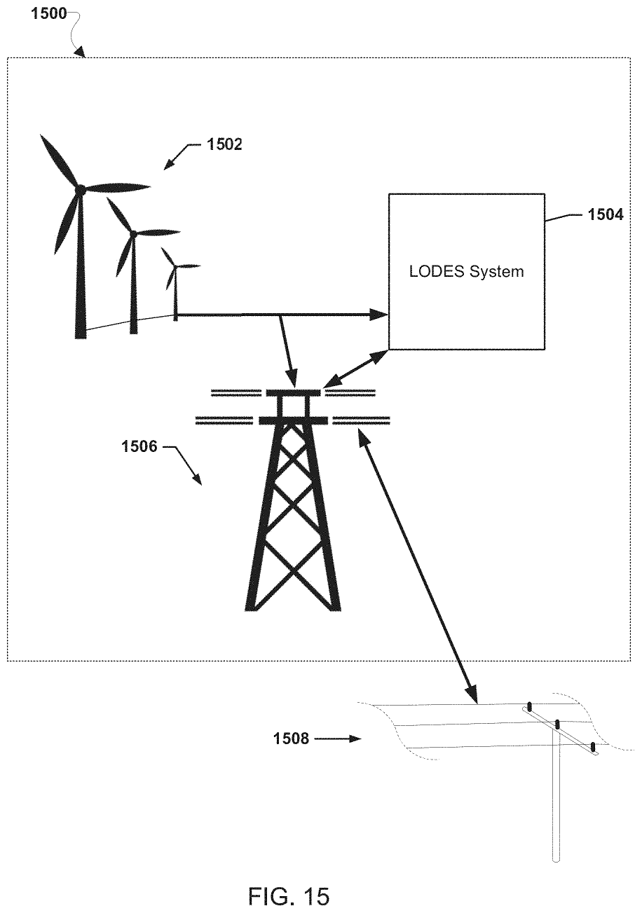

FIGS. 15-23 illustrate various example systems in which one or more aspects of the various embodiments may be used as part of bulk energy storage systems, such as LODES systems, SDES systems, etc. For example, various embodiments described herein with reference to FIGS. 1A-14 may be used as batteries for bulk energy storage systems, such as LODES systems, SDES systems, etc. and/or various electrodes as described herein may be used as components for bulk energy storage systems. As used herein, the term “LODES system” may mean a bulk energy storage system configured to may have a rated duration (energy/power ratio) of 24 hours (h) or greater, such as a duration of 24 h, a duration of 24 h to 50 h, a duration of greater than 50 h, a duration of 24 h to 150 h, a duration of greater than 150 h, a duration of 24 h to 200 h, a duration greater than 200 h, a duration of 24 h to 500 h, a duration greater than 500 h, etc.

FIG. 15 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The LODES system 1504 may be electrically connected to a wind farm 1502 and one or more transmission facilities 1506. The wind farm 1502 may be electrically connected to the transmission facilities 1506. The transmission facilities 1506 may be electrically connected to the grid 1508. The wind farm 1502 may generate power and the wind farm 1502 may output generated power to the LODES system 1504 and/or the transmission facilities 1506. The LODES system 1504 may store power received from the wind farm 1502 and/or the transmission facilities 1506. The LODES system 1504 may output stored power to the transmission facilities 1506. The transmission facilities 1506 may output power received from one or both of the wind farm 1502 and LODES system 1504 to the grid 1508 and/or may receive power from the grid 1508 and output that power to the LODES system 1504. Together the wind farm 1502, the LODES system 1504, and the transmission facilities 1506 may constitute a power plant 1500 that may be a combined power generation, transmission, and storage system. The power generated by the wind farm 1502 may be directly fed to the grid 1508 through the transmission facilities 1506, or may be first stored in the LODES system 1504. In certain cases, the power supplied to the grid 1508 may come entirely from the wind farm 1502, entirely from the LODES system 1504, or from a combination of the wind farm 1502 and the LODES system 1504. The dispatch of power from the combined wind farm 1502 and LODES system 1504 power plant 1500 may be controlled according to a determined long-range (multi-day or even multi-year) schedule, or may be controlled according to a day-ahead (15 hour advance notice) market, or may be controlled according to an hour-ahead market, or may be controlled in response to real time pricing signals.

As one example of operation of the power plant 1500, the LODES system 1504 may be used to reshape and “firm” the power produced by the wind farm 1502. In one such example, the wind farm 1502 may have a peak generation output (capacity) of 260 megawatts (MW) and a capacity factor (CF) of 41%. The LODES system 1504 may have a power rating (capacity) of 106 MW, a rated duration (energy/power ratio) of 150 hours (h), and an energy rating of 15,900 megawatt hours (MWh). In another such example, the wind farm 1502 may have a peak generation output (capacity) of 300 MW and a capacity factor (CF) of 41%. The LODES system 1504 may have a power rating of 106 MW, a rated duration (energy/power ratio) of 200 h and an energy rating of 21,200 MWh. In another such example, the wind farm 1502 may have a peak generation output (capacity) of 176 MW and a capacity factor (CF) of 53%. The LODES system 1504 may have a power rating (capacity) of 88 MW, a rated duration (energy/power ratio) of 150 h and an energy rating of 13,200 MWh. In another such example, the wind farm 1502 may have a peak generation output (capacity) of 277 MW and a capacity factor (CF) of 41%. The LODES system 1504 may have a power rating (capacity) of 97 MW, a rated duration (energy/power ratio) of 50 h and an energy rating of 4,850 MWh. In another such example, the wind farm 1502 may have a peak generation output (capacity) of 315 MW and a capacity factor (CF) of 41%. The LODES system 1504 may have a power rating (capacity) of 110 MW, a rated duration (energy/power ratio) of 25 h and an energy rating of 2,750 MWh.

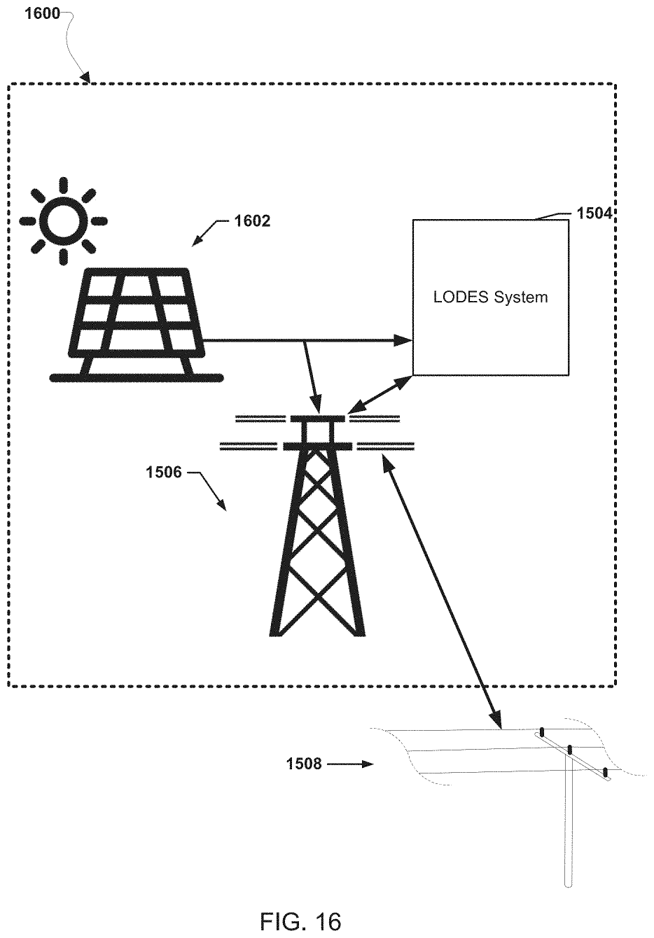

FIG. 16 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The system of FIG. 16 may be similar to the system of FIG. 15, except a photovoltaic (PV) farm 1602 may be substituted for the wind farm 1502. The LODES system 1504 may be electrically connected to the PV farm 1602 and one or more transmission facilities 1506. The PV farm 1602 may be electrically connected to the transmission facilities 1506. The transmission facilities 1506 may be electrically connected to the grid 1508. The PV farm 1602 may generate power and the PV farm 1602 may output generated power to the LODES system 1504 and/or the transmission facilities 1506. The LODES system 1504 may store power received from the PV farm 1602 and/or the transmission facilities 1506. The LODES system 1504 may output stored power to the transmission facilities 1506. The transmission facilities 1506 may output power received from one or both of the PV farm 1602 and LODES system 1504 to the grid 1508 and/or may receive power from the grid 1508 and output that power to the LODES system 1504. Together the PV farm 1602, the LODES system 1504, and the transmission facilities 1506 may constitute a power plant 1600 that may be a combined power generation, transmission, and storage system. The power generated by the PV farm 1602 may be directly fed to the grid 1508 through the transmission facilities 1506, or may be first stored in the LODES system 1504. In certain cases, the power supplied to the grid 1508 may come entirely from the PV farm 1602, entirely from the LODES system 1504, or from a combination of the PV farm 1602 and the LODES system 1504. The dispatch of power from the combined PV farm 1602 and LODES system 1504 power plant 1600 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 1600, the LODES system 1504 may be used to reshape and “firm” the power produced by the PV farm 1602. In one such example, the PV farm 1602 may have a peak generation output (capacity) of 490 MW and a capacity factor (CF) of 24%. The LODES system 1504 may have a power rating (capacity) of 340 MW, a rated duration (energy/power ratio) of 150 h and an energy rating of 51,000 MWh. In another such example, the PV farm 1602 may have a peak generation output (capacity) of 680 MW and a capacity factor (CF) of 24%. The LODES system 1504 may have a power rating (capacity) of 410 MW, a rated duration (energy/power ratio) of 200 h, and an energy rating of 82,000 MWh. In another such example, the PV farm 1602 may have a peak generation output (capacity) of 330 MW and a capacity factor (CF) of 31%. The LODES system 1504 may have a power rating (capacity) of 215 MW, a rated duration (energy/power ratio) of 150 h, and an energy rating of 32,250 MWh. In another such example, the PV farm 1602 may have a peak generation output (capacity) of 510 MW and a capacity factor (CF) of 24%. The LODES system 1504 may have a power rating (capacity) of 380 MW, a rated duration (energy/power ratio) of 50 h, and an energy rating of 19,000 MWh. In another such example, the PV farm 1602 may have a peak generation output (capacity) of 630 MW and a capacity factor (CF) of 24%. The LODES system 1504 may have a power rating (capacity) of 380 MW, a rated duration (energy/power ratio) of 25 h, and an energy rating of 9,500 MWh.

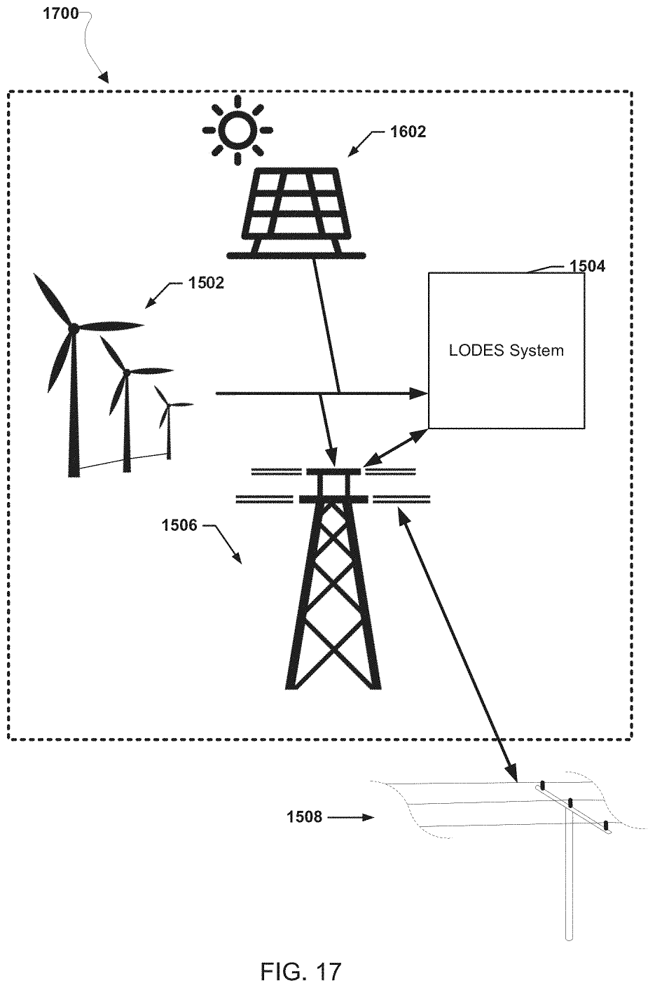

FIG. 17 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The system of FIG. 17 may be similar to the systems of FIGS. 15 and 16, except the wind farm 1502 and the photovoltaic (PV) farm 1602 may both be power generators working together in the power plant 1700. Together the PV farm 1602, wind farm 1502, the LODES system 1504, and the transmission facilities 1506 may constitute the power plant 1700 that may be a combined power generation, transmission, and storage system. The power generated by the PV farm 1602 and/or the wind farm 1502 may be directly fed to the grid 1508 through the transmission facilities 1506, or may be first stored in the LODES system 1504. In certain cases, the power supplied to the grid 1508 may come entirely from the PV farm 1602, entirely from the wind farm 1502, entirely from the LODES system 1504, or from a combination of the PV farm 1602, the wind farm 1502, and the LODES system 1504. The dispatch of power from the combined wind farm 1502, PV farm 1602, and LODES system 1504 power plant 1700 may be controlled according to a determined long-range (multi-day or even multi-year) schedule, or may be controlled according to a day-ahead (24 hour advance notice) market, or may be controlled according to an hour-ahead market, or may be controlled in response to real time pricing signals.

As one example of operation of the power plant 1700, the LODES system 1504 may be used to reshape and “firm” the power produced by the wind farm 1502 and the PV farm 1602. In one such example, the wind farm 1502 may have a peak generation output (capacity) of 126 MW and a capacity factor (CF) of 41% and the PV farm 1602 may have a peak generation output (capacity) of 126 MW and a capacity factor (CF) of 24%. The LODES system 1504 may have a power rating (capacity) of 63 MW, a rated duration (energy/power ratio) of 150 h, and an energy rating of 9,450 MWh. In another such example, the wind farm 1502 may have a peak generation output (capacity) of 170 MW and a capacity factor (CF) of 41% and the PV farm 1602 may have a peak generation output (capacity) of 110 MW and a capacity factor (CF) of 24%. The LODES system 1504 may have a power rating (capacity) of 57 MW, a rated duration (energy/power ratio) of 200 h, and an energy rating of 11,400 MWh. In another such example, the wind farm 1502 may have a peak generation output (capacity) of 105 MW and a capacity factor (CF) of 51% and the PV farm 1602 may have a peak generation output (capacity) of 70 MW and a capacity factor (CF) of 31 The LODES system 1504 may have a power rating (capacity) of 61 MW, a rated duration (energy/power ratio) of 150 h, and an energy rating of 9,150 MWh. In another such example, the wind farm 1502 may have a peak generation output (capacity) of 135 MW and a capacity factor (CF) of 41% and the PV farm 1602 may have a peak generation output (capacity) of 90 MW and a capacity factor (CF) of 24%. The LODES system 1504 may have a power rating (capacity) of 68 MW, a rated duration (energy/power ratio) of 50 h, and an energy rating of 3,400 MWh. In another such example, the wind farm 1502 may have a peak generation output (capacity) of 144 MW and a capacity factor (CF) of 41% and the PV farm 1602 may have a peak generation output (capacity) of 96 MW and a capacity factor (CF) of 24%. The LODES system 1504 may have a power rating (capacity) of 72 MW, a rated duration (energy/power ratio) of 25 h, and an energy rating of 1,800 MWh.

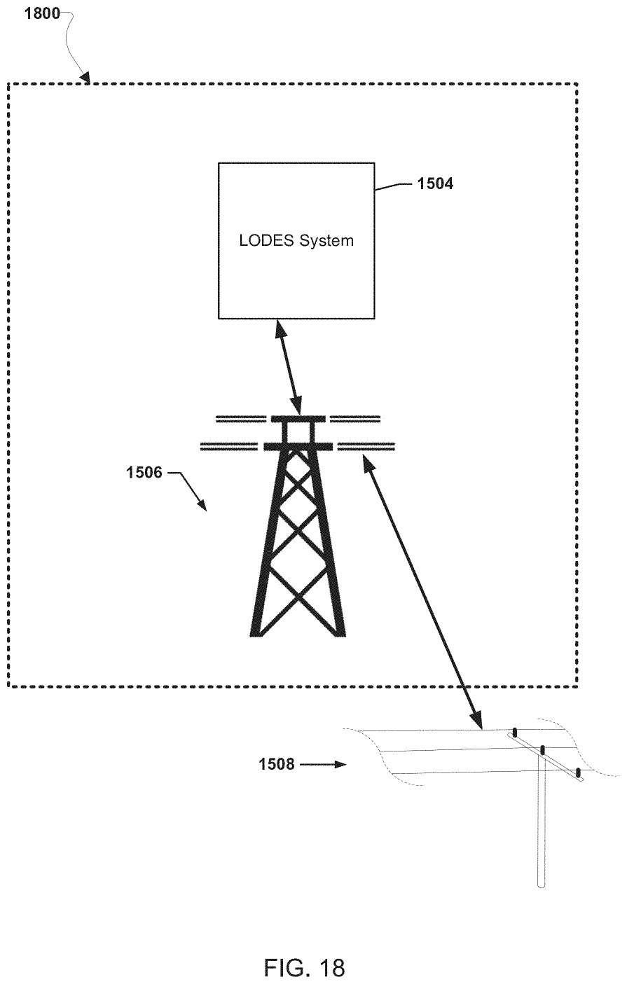

FIG. 18 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The LODES system 1504 may be electrically connected to one or more transmission facilities 1506. In this manner, the LODES system 1504 may operate in a “stand-alone” manner to arbiter energy around market prices and/or to avoid transmission constraints. The LODES system 1504 may be electrically connected to one or more transmission facilities 1506. The transmission facilities 1506 may be electrically connected to the grid 1508. The LODES system 1504 may store power received from the transmission facilities 1506. The LODES system 1504 may output stored power to the transmission facilities 1506. The transmission facilities 1506 may output power received from the LODES system 1504 to the grid 1508 and/or may receive power from the grid 1508 and output that power to the LODES system 1504.

Together the LODES system 1504 and the transmission facilities 1506 may constitute a power plant 900. As an example, the power plant 900 may be situated downstream of a transmission constraint, close to electrical consumption. In such an example downstream situated power plant 1800, the LODES system 1504 may have a duration of 24 h to 500 h and may undergo one or more full discharges a year to support peak electrical consumptions at times when the transmission capacity is not sufficient to serve customers. Additionally in such an example downstream situated power plant 1800, the LODES system 1504 may undergo several shallow discharges (daily or at higher frequency) to arbiter the difference between nighttime and daytime electricity prices and reduce the overall cost of electrical service to customer. As a further example, the power plant 1800 may be situated upstream of a transmission constraint, close to electrical generation. In such an example upstream situated power plant 1800, the LODES system 1504 may have a duration of 24 h to 500 h and may undergo one or more full charges a year to absorb excess generation at times when the transmission capacity is not sufficient to distribute the electricity to customers. Additionally in such an example upstream situated power plant 1800, the LODES system 1504 may undergo several shallow charges and discharges (daily or at higher frequency) to arbiter the difference between nighttime and daytime electricity prices and maximize the value of the output of the generation facilities.

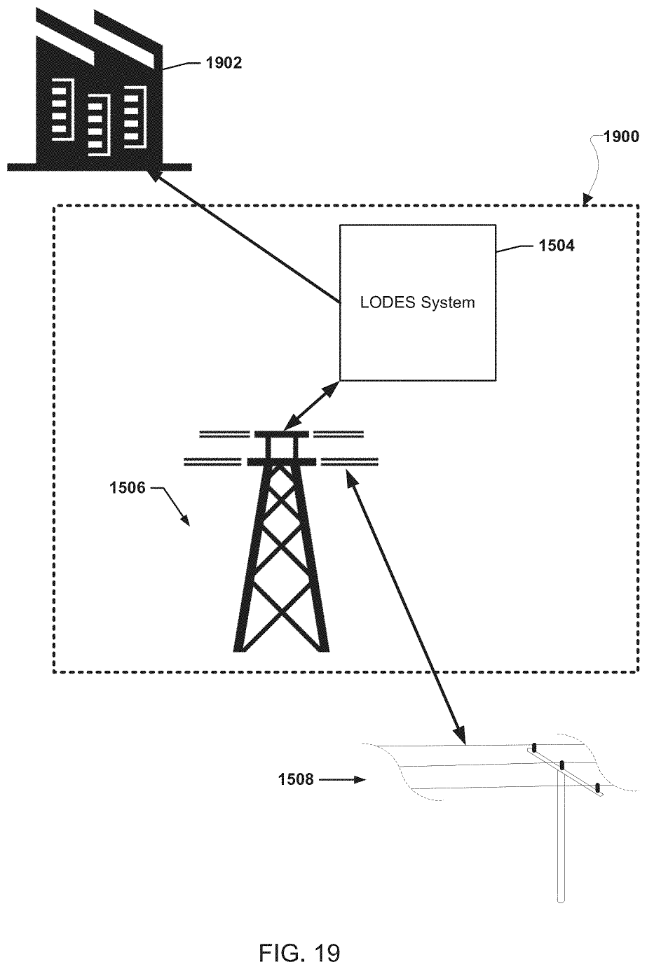

FIG. 19 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The LODES system 1504 may be electrically connected to a commercial and industrial (C&I) customer 1902, such as a data center, factory, etc. The LODES system 1504 may be electrically connected to one or more transmission facilities 1506. The transmission facilities 1506 may be electrically connected to the grid 1508. The transmission facilities 1506 may receive power from the grid 1508 and output that power to the LODES system 1504. The LODES system 1504 may store power received from the transmission facilities 1506. The LODES system 1504 may output stored power to the C&I customer 1902. In this manner, the LODES system 1504 may operate to reshape electricity purchased from the grid 1508 to match the consumption pattern of the C&I customer 1902.

Together, the LODES system 1504 and transmission facilities 1506 may constitute a power plant 1900. As an example, the power plant 1900 may be situated close to electrical consumption, i.e., close to the C&I customer 1902, such as between the grid 1508 and the C&I customer 1902. In such an example, the LODES system 1504 may have a duration of 24 h to 500 h and may buy electricity from the markets and thereby charge the LODES system 1504 at times when the electricity is cheaper. The LODES system 1504 may then discharge to provide the C&I customer 1902 with electricity at times when the market price is expensive, therefore offsetting the market purchases of the C&I customer 1902. As an alternative configuration, rather than being situated between the grid 1508 and the C&I customer 1902, the power plant 1900 may be situated between a renewable source, such as a PV farm, wind farm, etc., and the transmission facilities 1506 may connect to the renewable source. In such an alternative example, the LODES system 1504 may have a duration of 24 h to 500 h, and the LODES system 1504 may charge at times when renewable output may be available. The LODES system 1504 may then discharge to provide the C&I customer 1902 with renewable generated electricity so as to cover a portion, or the entirety, of the C&I customer 1902 electricity needs.

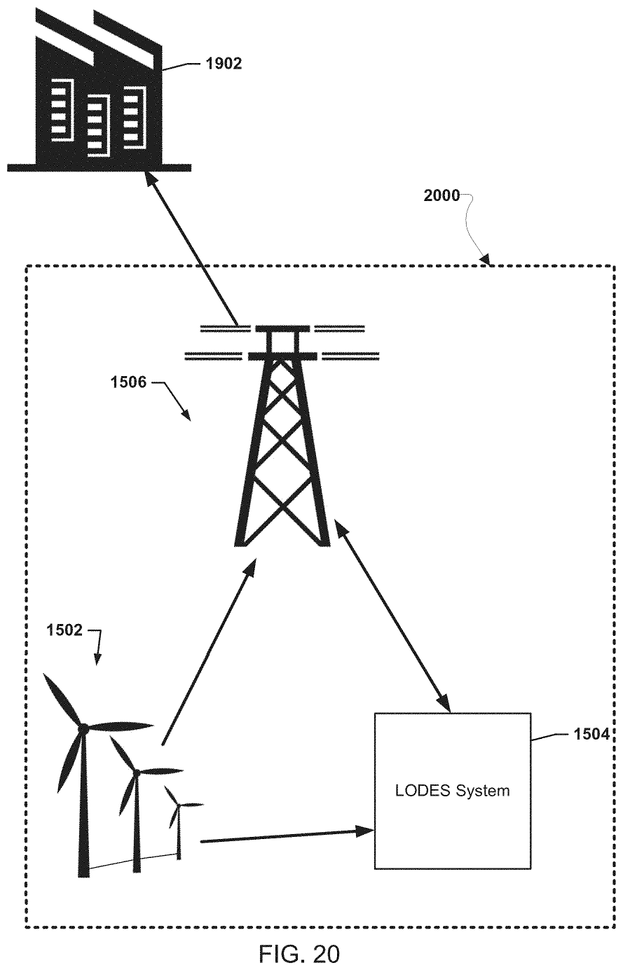

FIG. 20 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The LODES system 1504 may be electrically connected to a wind farm 1502 and one or more transmission facilities 1506. The wind farm 1502 may be electrically connected to the transmission facilities 1506. The transmission facilities 1506 may be electrically connected to a C&I customer 1902. The wind farm 1502 may generate power and the wind farm 1502 may output generated power to the LODES system 1504 and/or the transmission facilities 1506. The LODES system 1504 may store power received from the wind farm 1502.

The LODES system 1504 may output stored power to the transmission facilities 1506. The transmission facilities 1506 may output power received from one or both of the wind farm 1502 and LODES system 1504 to the C&I customer 1902. Together the wind farm 1502, the LODES system 1504, and the transmission facilities 1506 may constitute a power plant 2000 that may be a combined power generation, transmission, and storage system. The power generated by the wind farm 1502 may be directly fed to the C&I customer 1902 through the transmission facilities 1506, or may be first stored in the LODES system 1504. In certain cases, the power supplied to the C&I customer 1902 may come entirely from the wind farm 1502, entirely from the LODES system 1504, or from a combination of the wind farm 1502 and the LODES system 1504. The LODES system 1504 may be used to reshape the electricity generated by the wind farm 1502 to match the consumption pattern of the C&I customer 1902. In one such example, the LODES system 1504 may have a duration of 24 h to 500 h and may charge when renewable generation by the wind farm 1502 exceeds the C&I customer 1902 load. The LODES system 1504 may then discharge when renewable generation by the wind farm 1502 falls short of C&I customer 1902 load so as to provide the C&I customer 1902 with a firm renewable profile that offsets a fraction, or all of, the C&I customer 1902 electrical consumption.

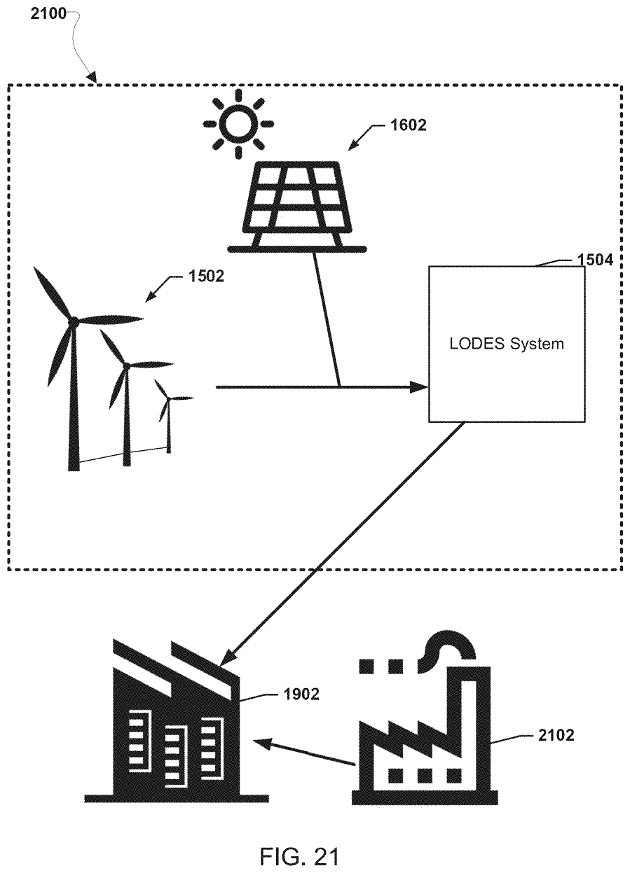

FIG. 21 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The LODES system 1504 may be part of a power plant 2100 that is used to integrate large amounts of renewable generation in microgrids and harmonize the output of renewable generation by, for example a PV farm 1602 and wind farm 1502, with existing thermal generation by, for example a thermal power plant 2102 (e.g., a gas plant, a coal plant, a diesel generator set, etc., or a combination of thermal generation methods), while renewable generation and thermal generation supply the C&I customer 1902 load at high availability. Microgrids, such as the microgrid constituted by the power plant 2100 and the thermal power plant 2102, may provide availability that is 90% or higher. The power generated by the PV farm 1602 and/or the wind farm 1502 may be directly fed to the C&I customer 1902, or may be first stored in the LODES system 1504.

In certain cases, the power supplied to the C&I customer 1902 may come entirely from the PV farm 1602, entirely from the wind farm 1502, entirely from the LODES system 1504, entirely from the thermal power plant 2102, or from any combination of the PV farm 1602, the wind farm 1502, the LODES system 1504, and/or the thermal power plant 2102. As examples, the LODES system 1504 of the power plant 2100 may have a duration of 24 h to 500 h. As a specific example, the C&I customer 1902 load may have a peak of 100 MW, the LODES system 1504 may have a power rating of 14 MW and duration of 150 h, natural gas may cost $6/million British thermal units (MMBTU), and the renewable penetration may be 58%. As another specific example, the C&I customer 1902 load may have a peak of 100 MW, the LODES system 1504 may have a power rating of 25 MW and duration of 150 h, natural gas may cost $8/MMBTU, and the renewable penetration may be 65%.

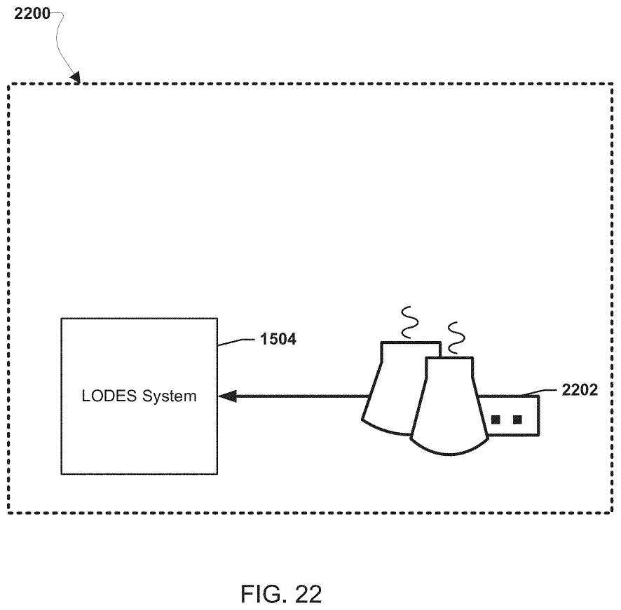

FIG. 22 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The LODES system 1504 may be used to augment a nuclear plant 2202 (or other inflexible generation facility, such as a thermal, a biomass, etc., and/or any other type plant having a ramp-rate lower than 50% of rated power in one hour and a high capacity factor of 80% or higher) to add flexibility to the combined output of the power plant 2200 constituted by the combined LODES system 1504 and nuclear plant 2202. The nuclear plant 2202 may operate at high capacity factor and at the highest efficiency point, while the LODES system 1504 may charge and discharge to effectively reshape the output of the nuclear plant 2202 to match a customer electrical consumption and/or a market price of electricity. As examples, the LODES system 1504 of the power plant 2200 may have a duration of 24 h to 500 h. In one specific example, the nuclear plant 2202 may have 1,000 MW of rated output and the nuclear plant 2202 may be forced into prolonged periods of minimum stable generation or even shutdowns because of depressed market pricing of electricity. The LODES system 1504 may avoid facility shutdowns and charge at times of depressed market pricing; and the LODES system 1504 may subsequently discharge and boost total output generation at times of inflated market pricing.

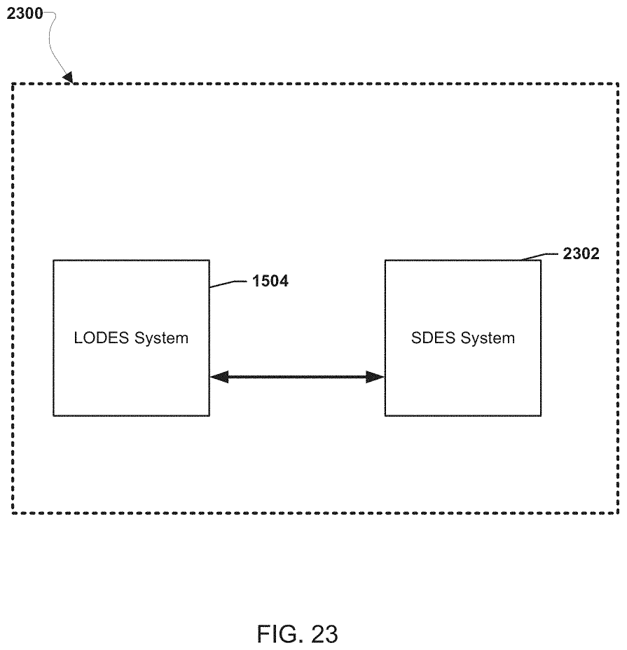

FIG. 23 illustrates an example system in which one or more aspects of the various embodiments may be used as part of bulk energy storage system. As a specific example, the bulk energy storage system incorporating one or more aspects of the various embodiments may be a LODES system 1504. As an example, the LODES system 1504 may include various embodiment batteries described herein, various electrodes described herein, etc. The LODES system 1504 may operate in tandem with a SDES system 2302. Together the LODES system 1504 and SDES system 2302 may constitute a power plant 2300. As an example, the LODES system 1504 and SDES system 2302 may be co-optimized whereby the LODES system 1504 may provide various services, including long-duration back-up and/or bridging through multi-day fluctuations (e.g., multi-day fluctuations in market pricing, renewable generation, electrical consumption, etc.), and the SDES system 2302 may provide various services, including fast ancillary services (e.g. voltage control, frequency regulation, etc.) and/or bridging through intra-day fluctuations (e.g., intra-day fluctuations in market pricing, renewable generation, electrical consumption, etc.). The SDES system 2302 may have durations of less than 10 hours and round-trip efficiencies of greater than 80%. The LODES system 1504 may have durations of 24 h to 500 h and round-trip efficiencies of greater than 40%. In one such example, the LODES system 1504 may have a duration of 150 hours and support customer electrical consumption for up to a week of renewable under-generation. The LODES system 1504 may also support customer electrical consumption during intra-day under-generation events, augmenting the capabilities of the SDES system 2302. Further, the SDES system 2302 may supply customers during intra-day under-generation events and provide power conditioning and quality services such as voltage control and frequency regulation.

Various embodiments may include a battery comprising: a first electrode; an electrolyte; and a second electrode, wherein at least one of the first electrode and the second electrode comprises iron agglomerates. In some embodiments, the electrolyte comprises a soluble sulfide. In some embodiments, at least one of the first electrode and the second electrode further comprises a solid sulfide. In some embodiments, at least one of the first electrode or the second electrode is subjected to a compressive load. In some embodiments, the compressive load is applied on one side of at least one of the first electrode or second electrode by a current collecting member. In some embodiments, the iron agglomerates comprise at least one of magnetite, hematite, or wustite. In some embodiments, the electrolyte comprises a corrosion inhibitor. In some embodiments, the iron agglomerates have an average length ranging from about 50 um to about 50 mm. In some embodiments, the iron agglomerates have an average internal porosity ranging from about 10% to about 90% by volume. In some embodiments, the iron agglomerates have an average specific surface area ranging from about 0.1 m²/g to about 25 m²/g. In some embodiments, the electrolyte is infiltrated between the iron agglomerates. In some embodiments, the electrolyte comprises 1-octanethiol. In some embodiments, the electrolyte comprises a molybdate anion and a sulfide anion. In some embodiments, the iron agglomerates are supported within a metal textile mesh providing compressive force and current collection for the iron agglomerates. In some embodiments, the iron agglomerates are bonded to one another and bonded to a current collector.

Various embodiments may include a battery comprising: a first electrode; an electrolyte; and a second electrode, wherein at least one of the first electrode and the second electrode comprises atomized metal powder. In some embodiments, the electrolyte comprises a soluble sulfide. In some embodiments, at least one of the first electrode and the second electrode further comprises a solid sulfide. In some embodiments, at least one of the first electrode or the second electrode is subjected to a compressive load. In some embodiments, the compressive load is applied on one side of at least one of the first electrode or second electrode by a current collecting member. In some embodiments, the atomized metal powder comprise at least one of magnetite, hematite, or wustite. In some embodiments, the electrolyte comprises a corrosion inhibitor. In some embodiments, the electrolyte is infiltrated between the atomized metal powder. In some embodiments, the electrolyte comprises 1-octanethiol. In some embodiments, the electrolyte comprises a molybdate anion and a sulfide anion. In some embodiments, the atomized metal powder is supported within a metal textile mesh providing compressive force and current collection for the atomized metal powder. In some embodiments, the atomized metal powder is bonded together and bonded to a current collector.

Various embodiments include a method of making an electrode, comprising: electrochemically producing metal powder; and forming the metal powder into an electrode. In some embodiments, electrochemically producing the metal powder comprises electrochemically producing the metal powder at least in part using a molten salt electrochemistry. In some embodiments, electrochemically producing the metal powder comprises electrochemically producing the metal powder at least in part using gas atomization. In some embodiments, electrochemically producing the metal powder comprises electrochemically producing the metal powder at least in part using water atomization.

Various embodiments may include a bulk energy storage system, comprising: one or more batteries, wherein at least one of the one or more batteries comprises: a first electrode; an electrolyte; and a second electrode, wherein at least one of the first electrode and the second electrode comprises iron agglomerates. In some embodiments, the bulk energy storage system is a long duration energy storage (LODES) system. In some embodiments, the electrolyte comprises a soluble sulfide. In some embodiments, at least one of the first electrode and the second electrode further comprises a solid sulfide. In some embodiments, at least one of the first electrode or the second electrode is subjected to a compressive load. In some embodiments, the compressive load is applied on one side of at least one of the first electrode or second electrode by a current collecting member. In some embodiments, the iron agglomerates comprise at least one of magnetite, hematite, or wustite. In some embodiments, the electrolyte comprises a corrosion inhibitor. In some embodiments, the iron agglomerates have an average length ranging from about 50 um to about 50 mm. In some embodiments, the iron agglomerates have an average internal porosity ranging from about 10% to about 90% by volume. In some embodiments, the iron agglomerates have an average specific surface area ranging from about 0.1 m²/g to about 25 m²/g. In some embodiments, the electrolyte is infiltrated between the iron agglomerates. In some embodiments, the electrolyte comprises 1-octanethiol. In some embodiments, the electrolyte comprises a molybdate anion and a sulfide anion. In some embodiments, the iron agglomerates are supported within a metal textile mesh providing compressive force and current collection for the iron agglomerates. In some embodiments, the iron agglomerates are bonded to one another and bonded to a current collector.

Various embodiments may include a bulk energy storage system, comprising: one or more batteries, wherein at least one of the one or more batteries comprises: a first electrode; an electrolyte; and a second electrode, wherein at least one of the first electrode and the second electrode comprises atomized metal powder. In some embodiments, the bulk energy storage system is a long duration energy storage (LODES) system. In some embodiments, the electrolyte comprises a soluble sulfide. In some embodiments, at least one of the first electrode and the second electrode further comprises a solid sulfide. In some embodiments, at least one of the first electrode or the second electrode is subjected to a compressive load. In some embodiments, the compressive load is applied on one side of at least one of the first electrode or second electrode by a current collecting member. In some embodiments, the atomized metal powder comprise at least one of magnetite, hematite, or wustite. In some embodiments, the electrolyte comprises a corrosion inhibitor. In some embodiments, the electrolyte is infiltrated between the atomized metal powder. In some embodiments, the electrolyte comprises 1-octanethiol. In some embodiments, the electrolyte comprises a molybdate anion and a sulfide anion. In some embodiments, the atomized metal powder is supported within a metal textile mesh providing compressive force and current collection for the atomized metal powder. In some embodiments, the atomized metal powder is bonded together and bonded to a current collector.

Implementation examples are described in the following paragraphs. While some of the following implementation examples are described in terms of example methods, further example implementations may include: the example methods discussed in the following paragraphs implemented to form an iron electrode and/or an electrochemical system.

Example 1. A method for iron electrode manufacture, comprising providing a particulate iron material into an apparatus, applying pressure and/or heat to the particulate iron material in the apparatus for a time period to form an electrode having therein conductive connections between particles of the particulate iron material.

Example 2. The method of example 1, further comprising providing the electrode into an electrochemical system without applying an external current collector or packing to the electrode.

Example 3. The method of any of examples 1-2, wherein the apparatus comprises compaction rollers and the applied pressure is generated at least in part by the compaction rollers.

Example 4. The method of any of examples 1-2, wherein the pressure and/or heat are applied in a Hot Isostatic Pressing (HIP) process, a uniaxial hot pressing process, a hot roll compaction process, a hot briquetting process, or a hot forging process.

Example 5. The method of any of examples 1-4, wherein the applied heat results in an elevated temperature in a range from about 300 to about 1000 degrees Celsius; the applied pressure is in a range from about 0.1 to about 200 MPa; the applied pressure is applied by a uniaxial, biaxial, triaxial, isostatic, and/or roller method; and/or the time period is in a range from about 1 second to about 24 hours.

Example 6. The method of example 5, wherein the applied pressure is in a range from about 1 to about 100 MPa.

Example 7. The method of any of examples 1-6, wherein a greater than 50 vol. % microporosity within the particles of the particulate iron material is maintained after applying the pressure and elevated temperature.

Example 8. The method of any of examples 1-7, wherein the electrode has a greater than 50 vol. % microporosity within the particles of the particulate iron material after applying the pressure and elevated temperature.

Example 9. The method of any of examples 1-8, wherein the pressure and/or heat are applied in a non-oxidizing atmosphere.

Example 10. The method of any of examples 1-8, further comprising removing oxidation after formation of the electrode.

Example 11. The method of any of examples 1-10, further comprising forming texture on the iron electrode.

Example 12. The method of example 11, wherein the texture comprises variable thickness channels.

Example 13. The method of any of examples 1-12, wherein the apparatus comprises a tool portion with conical protrusions there from.

Example 14. The method of any of examples 1-12, wherein the apparatus comprises a roller with teeth.

Example 15. The method of any of examples 1-12, wherein the apparatus comprises a textured roller.

Example 16. The method of any of examples 1-15, further comprising performing surface cleaning of the particulate iron material prior to providing the particulate iron material into the apparatus.

Example 17. The method of any of examples 1-16, further comprising, prior to providing the particulate iron material into the apparatus, preheating the particulate iron material and/or mechanically changing one or more aspects of the particulate iron material.

Example 18. The method of any of examples 1-17, further comprising, prior to providing the particulate iron material into the apparatus, controlling a particle size of the particulate iron material.

Example 19. The method of example 18, wherein controlling the particle size of the particulate iron material comprises reducing a particle size of the particulate iron from a first particle size to a second particle size.

Example 20. The method of example 19, wherein the second particle size is one half of the first particle size.

Example 21. The method of example 19, wherein the second particle size is one quarter of the first particle size.

Example 22. The method of any of examples 19-21, wherein a particle size reduction technique comprises one or more of jaw crushing, hammer milling, gyratory milling, and pulverizing with a parallel plate pulverizer.

Example 23. The method of any of examples 1-22, wherein providing the particulate iron material into the apparatus comprises at least in part a thermal spraying process depositing a portion of the particulate iron material onto a substrate and/or bed of DRI.

Example 24. The method of any of examples 1-22, wherein providing the particulate iron material into the apparatus comprises at least in part using an additive manufacturing process.

Example 25. The method of any of examples 1-24, wherein forming the electrode additionally comprises using one or more of ultrasonic compaction/vibration, slicing, machining, cold compaction, cold extrusion, casting, different temperature compaction, and compaction and bonding to at least in part form the electrode.

Example 26. The method of any of examples 1-25, wherein applying pressure and/or heat comprises application of ˜0.5-50 MPa pressure at room temperature or application of ˜0.1-10 MPa at a temperature >400° C. and <1200° C.

Example 27. The method of any of examples 1-26, comprising applying heat to the particulate iron material that iron carbide decomposes to form iron and graphite.

Example 28. The method of example 27, wherein the applied heat is at a temperature of 300-727° C.

Example 29. The method of any of examples 1-28, further comprising applying pressure and/or heat in an oxygen atmosphere at a temperature from 700-900° C.

Example 30. An iron electrode made by a method of any of examples 1-29.

Example 31. An iron electrode, comprising: metallurgically-bonded sponge iron particles, wherein the microporosity with the sponge iron particles is >50 vol % and the particle size of the sponge iron particles is >100 microns.

Example 32. The iron electrode of example 31, wherein the iron electrode is made by any of the methods of any of examples 1-29.

Example 33. An electrochemical system comprising an iron electrode made by a method of any of examples 1-29 and/or an iron electrode according to any of examples 30-32.

Example 34. The electrochemical system of example 33, wherein the electrochemical system is a long duration energy storage system.

The foregoing method descriptions are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not necessarily intended to limit the order of the steps; these words may be used to guide the reader through the description of the methods. Further, any reference to claim elements in the singular, for example, using the articles “a,” “an” or “the” is not to be construed as limiting the element to the singular. Further, any step of any embodiment described herein can be used in any other embodiment.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A method for iron electrode manufacture, comprising:
providing a particulate iron material into an apparatus; and
applying pressure and/or heat to the particulate iron material in the apparatus for a time period to form an electrode having therein conductive connections between particles of the particulate iron material.

2. The method of claim 1, further comprising providing the electrode into an electrochemical system without applying an external current collector or packing to the electrode.

3. The method of claim 1, wherein the apparatus comprises compaction rollers and the applied pressure is generated at least in part by the compaction rollers.

4. The method of claim 1, wherein the pressure and/or heat are applied in a Hot Isostatic Pressing (HIP) process, a uniaxial hot pressing process, a hot roll compaction process, a hot briquetting process, or a hot forging process.

5. The method of claim 1, wherein:
the applied heat results in an elevated temperature in a range from about 300 to about 1000 degrees Celsius;
the applied pressure is in a range from about 0.1 to about 200 MPa;
the applied pressure is applied by a uniaxial, biaxial, triaxial, isostatic, and/or roller method; and/or
the time period is in a range from about 1 second to about 24 hours.

6. The method of claim 5, wherein the applied pressure is in a range from about 1 to about 100 MPa.

7. The method of claim 1, wherein a greater than 50 vol. % microporosity within the particles of the particulate iron material is maintained after applying the pressure and elevated temperature.

8. The method of claim 1, wherein the electrode has a greater than 50 vol. % microporosity within the particles of the particulate iron material after applying the pressure and elevated temperature.

9. The method of claim 1, wherein the pressure and/or heat are applied in a non-oxidizing atmosphere.

10. The method of claim 1, further comprising removing oxidation after formation of the electrode.

11. The method of claim 1, further comprising:
forming texture on the iron electrode.

12. The method of claim 11, wherein the texture comprises variable thickness channels.

13. The method of claim 1, wherein the apparatus comprises a tool portion with conical protrusions therefrom.

14. The method of claim 1, wherein the apparatus comprises a roller with teeth.

15. The method of claim 1, wherein the apparatus comprises a textured roller.

16. The method of claim 1, further comprising performing surface cleaning of the particulate iron material prior to providing the particulate iron material into the apparatus.

17. The method of claim 1, further comprising, prior to providing the particulate iron material into the apparatus, preheating the particulate iron material and/or mechanically changing one or more aspects of the particulate iron material.

18. The method of claim 1, further comprising, prior to providing the particulate iron material into the apparatus, controlling a particle size of the particulate iron material.

19. The method of claim 18, wherein controlling the particle size of the particulate iron material comprises reducing a particle size of the particulate iron from a first particle size to a second particle size.

20. The method of claim 19, wherein the second particle size is one half of the first particle size.

21. The method of claim 19, wherein the second particle size is one quarter of the first particle size.

22. The method of claim 19, wherein a particle size reduction technique comprises one or more of jaw crushing, hammer milling, gyratory milling, and pulverizing with a parallel plate pulverizer.

23. The method of claim 1, wherein providing the particulate iron material into the apparatus comprises at least in part a thermal spraying process depositing a portion of the particulate iron material onto a substrate and/or bed of direct reduced iron.

24. The method of claim 1, wherein providing the particulate iron material into the apparatus comprises at least in part using an additive manufacturing process.

25. The method of claim 1, wherein forming the electrode additionally comprises using one or more of ultrasonic compaction/vibration, slicing, machining, cold compaction, cold extrusion, casting, different temperature compaction, and compaction and bonding to at least in part form the electrode.

26. The method of claim 1, wherein applying pressure and/or heat comprises application of ˜0.5-50 MPa pressure at room temperature or application of ˜0.1-10 MPa at a temperature >400° C. and <1200° C.

27. The method of claim 1, comprising applying heat to the particulate iron material that iron carbide decomposes to form iron and graphite.

28. The method of claim 27, wherein the applied heat is at a temperature of 300-727° C.

29. The method of claim 1, further comprising applying pressure and/or heat in an oxygen atmosphere at a temperature from 700-900° C.

30. The method of claim 1, wherein the particles of the particulate iron material comprise metallurgically-bonded sponge iron particles, wherein the microporosity with the sponge iron particles is >50 vol % and the particle size of the sponge iron particles is >100 microns.

31. An iron electrode, comprising:
metallurgically-bonded sponge iron particles, wherein the microporosity with the sponge iron particles is >50 vol % and the particle size of the sponge iron particles is >100 microns.

32-34. (canceled)

35. A bulk energy storage system, comprising:
one or more batteries, wherein at least one of the one or more batteries comprises:
an iron electrode comprising metallurgically-bonded sponge iron particles, wherein the microporosity with the sponge iron particles is >50 vol % and the particle size of the sponge iron particles is >100 microns.

36. The bulk energy storage system of claim 35, wherein the bulk energy storage system is a long duration energy storage (LODES) system.
